(19) United States
(12) Patent Application Publication
(10) Pub. No.: US 2024/0014966 A1
(43) Pub. Date: Jan. 11, 2024

(54) FLEXIBLE APERIODIC SOUNDING REFERENCE SIGNAL TRIGGERING

(71) Applicant: QUALCOMM Incorporated, San Diego, CA (US)

(72) Inventors: Muhammad Sayed Khairy ABDELGHAFFAR, San Jose, CA (US); Alexandros MANOLAKOS, Escondido, CA (US)

(21) Appl. No.: 18/251,693

(22) PCT Filed: Nov. 22, 2021
(86) PCT No.: PCT/US2021/060342

§ 371 Date: May 3, 2023

(30) Foreign Application Priority Data
Dec. 14, 2020 (GR) 20200100724

(51) Int. Cl. H04L 5/00; H04W 72/044; H04W 72/231

(52) U.S. Cl. CPC H04L 5/0048; H04W 72/044; H04W 72/231

(57) ABSTRACT

Methods, systems, and devices for wireless communications are described. Generally, a base station may transmit a radio resource control (RRC) message including an indication of one or more available transmission time intervals (TTIs) for transmitting aperiodic sounding reference signals (SRSs). The base station may transmit one or more additional RRC messages, which may include an aperiodic SRS resource trigger list parameter. One or more code points for an SRS trigger may be mapped to the available TTIs indicated in the first RRC message. The base station may transmit a downlink control information (DCI) message, which may trigger SRS transmissions according to the RRC messages. The DCI message may include an SRS trigger, and may indicate one or more SRS resource sets on which to transmit aperiodic SRSs. The UE may interpret the trigger as indicating an available slot in which to transmit the SRSs based on the available TTIs.

### CROSS REFERENCE

The present application is a 371 national stage filing of International PCT Application No. PCT/US2021/060342 by Abdelghaffar et al. entitled “FLEXIBLE APERIODIC SOUNDING REFERENCE SIGNAL TRIGGERING,” filed Nov. 22, 2021; and claims priority to Greece Patent Application No. 20200100724 by Abdelghaffar et al., entitled “FLEXIBLE APERIODIC SOUNDING REFERENCE SIGNAL TRIGGERING” and filed Dec. 14, 2020, each of which is assigned to the assignee hereof, and each of which is expressly incorporated by reference in its entirety herein.

### FIELD OF TECHNOLOGY

The following relates to wireless communications, including flexible aperiodic sounding reference signal triggering.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal frequency division multiple access (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE). In some examples, a base station may configure one or more UEs to transmit aperiodic sounding reference signals (SRSs).

### SUMMARY

The described techniques relate to improved methods, systems, devices, and apparatuses that support flexible aperiodic sounding reference signal triggering. Generally, the described techniques relate to improved methods, systems, devices, and apparatuses that support flexible aperiodic sounding reference signal (SRS) triggering. Generally, a base station may transmit a radio resource control (RRC) message (e.g., an AvailableSlotList RRC parameter) including an indication of one or more available transmission time intervals (TTIs) (e.g., available slots) for transmitting aperiodic SRSs. The base station may transmit one or more additional RRC messages, which may include configuration information, such as an aperiodic SRS resource trigger list parameter. Such configuration information may provide one or more code points for an SRS trigger, which may be mapped to the available TTIs indicated in the first RRC message. Subsequently, the base station may transmit a downlink control information (DCI) message, which may trigger SRS transmissions according to the received RRC messages. The DCI message may include an SRS trigger (e.g., a two-bit aperiodic SRS trigger), and may indicate one or more SRS resource sets on which to transmit aperiodic SRSs. The UE may receive the DCI message, and may transmit one or more SRSs on the indicated aperiodic SRS resource sets. The UE may identify a code point (e.g., the SRS trigger) that is mapped to or otherwise corresponding to the first RRC message. For instance, the first RRC message may indicate a set of available TTIs, and each code point of the SRS trigger may be mapped to one available TTI. In some examples, the first RRC message may indicate a single available TTI (e.g., a single offset value), and each code point may correspond to an additional offset or delay that can be added to or otherwise combined with the indicated single available TTI. In some examples, one bit of the two-bit trigger may indicate one of a limited set of two configurations, and one bit of the two-bit trigger may indicate one of a limited set of two available TTIs in which to transmit the aperiodic SRSs.

A method for wireless communications at a user equipment (UE) is described. The method may include receiving, from a base station, a radio resource control message including an indication of one or more available transmission time intervals for transmitting aperiodic sounding reference signals, receiving, from the base station, a first downlink control information message triggering a transmission of one or more aperiodic sounding reference signals on a sounding reference signal resource set, and transmitting, to the base station during a first available transmission time interval, the one or more aperiodic sounding reference signals on the sounding reference signal resource set, where the transmitting during the first available transmission time interval is based on a first code point of the first downlink control information message and the indication of the one or more available transmission time intervals.

An apparatus for wireless communications at a UE is described. The apparatus may include a processor, memory in electronic communication with the processor, and instructions stored in the memory. The instructions may be executable by the processor to cause the apparatus to receive, from a base station, a radio resource control message including an indication of one or more available transmission time intervals for transmitting aperiodic sounding reference signals, receive, from the base station, a first downlink control information message triggering a transmission of one or more aperiodic sounding reference signals on a sounding reference signal resource set, and transmit, to the base station during a first available transmission time interval, the one or more aperiodic sounding reference signals on the sounding reference signal resource set, where the transmitting during the first available transmission time interval is based on a first code point of the first downlink control information message and the indication of the one or more available transmission time intervals.

Another apparatus for wireless communications at a UE is described. The apparatus may include means for receiving, from a base station, a radio resource control message including an indication of one or more available transmission time intervals for transmitting aperiodic sounding reference signals, means for receiving, from the base station, a first downlink control information message triggering a transmission of one or more aperiodic sounding reference signals on a sounding reference signal resource set, and means for transmitting, to the base station during a first available transmission time interval, the one or more aperiodic sounding reference signals on the sounding reference signal resource set, where the transmitting during the first available transmission time interval is based on a first code point of the first downlink control information message and the indication of the one or more available transmission time intervals.

A non-transitory computer-readable medium storing code for wireless communications at a UE is described. The code may include instructions executable by a processor to receive, from a base station, a radio resource control message including an indication of one or more available transmission time intervals for transmitting aperiodic sounding reference signals, receive, from the base station, a first downlink control information message triggering a transmission of one or more aperiodic sounding reference signals on a sounding reference signal resource set, and transmit, to the base station during a first available transmission time interval, the one or more aperiodic sounding reference signals on the sounding reference signal resource set, where the transmitting during the first available transmission time interval is based on a first code point of the first downlink control information message and the indication of the one or more available transmission time intervals.

In some examples of the method, apparatuses, and non-transitory computer-readable medium described herein, the indication of the one or more available transmission time intervals may include operations, features, means, or instructions for an indication of a set of multiple available transmission time intervals, each available transmission time interval of a set of available transmission time intervals corresponding to a respective code point of a set of codepoints including the first code point of the first downlink control information message.

In some examples of the method, apparatuses, and non-transitory computer-readable medium described herein, the indication of the one or more available transmission time intervals may include operations, features, means, or instructions for an indication of a single available transmission time interval, where a set of offset values from the single available transmission time interval correspond to respective code points of a set of codepoints including the first code point of the first downlink control information message.

Some examples of the method, apparatuses, and non-transitory computer-readable medium described herein may further include operations, features, means, or instructions for adding a first offset value of the set of offset values to the single available transmission time interval, the first offset value corresponding to the first code point and identifying, based on the adding, the first available transmission time interval.

In some examples of the method, apparatuses, and non-transitory computer-readable medium described herein, the indication of the one or more available transmission time intervals may include operations, features, means, or instructions for an indication of the first available transmission time interval and a second available transmission time interval.

Some examples of the method, apparatuses, and non-transitory computer-readable medium described herein may further include operations, features, means, or instructions for receiving, in the first downlink control information message, an aperiodic sounding reference signal trigger including the first code point, where the first code point includes a first bit of the aperiodic sounding reference signal trigger indicating a first sounding reference signal configuration and a second bit of the aperiodic sounding reference signal trigger indicating the first available transmission time interval.

Some examples of the method, apparatuses, and non-transitory computer-readable medium described herein may further include operations, features, means, or instructions for receiving, from the base station, a control message including an indication of one or more updated available transmission time intervals for transmitting aperiodic sounding reference signals, one or more updated values for a set of code points including the first code point, or any combination thereof.

In some examples of the method, apparatuses, and non-transitory computer-readable medium described herein, the control message includes a media access control (MAC) control element (CE).

In some examples of the method, apparatuses, and non-transitory computer-readable medium described herein, the indication of one or more updated available transmission time intervals or transmitting aperiodic sounding reference signals may include operations, features, means, or instructions for an instruction to add or remove one or more entries in a table indicating the available transmission time intervals, or an instruction to enable or disable one or more entries in a table indicating the available transmission time intervals, or both.

In some examples of the method, apparatuses, and non-transitory computer-readable medium described herein, the indication of one or more updated values for the set of code points may include operations, features, means, or instructions for an instruction to add or remove one or more code points of the set of code points, or an instruction to enable or disable one or more code points of the set of code points, or both.

In some examples of the method, apparatuses, and non-transitory computer-readable medium described herein, the MAC-CE includes an instruction to modify a mapping between the set of code points and the available transmission time intervals.

Some examples of the method, apparatuses, and non-transitory computer-readable medium described herein may further include operations, features, means, or instructions for receiving, from the base station, a second radio resource control message including a slot offset value indicating a second available transmission time interval for transmitting aperiodic sounding reference signals, receiving, from the base station, a second downlink control information message triggering a transmission of one or more aperiodic sounding reference signals on a second sounding reference signal resource set, and transmitting, to the base station during the second available transmission time interval, the one or more aperiodic sounding reference signals on the second sounding reference signal resource set, where the transmitting during the second available transmission time interval may be based on determining that one or more sounding reference signal configuration conditions may be satisfied.

Some examples of the method, apparatuses, and non-transitory computer-readable medium described herein may further include operations, features, means, or instructions for determining that the second radio resource control message does not include the indication of the one or more available transmission time intervals for transmitting aperiodic sounding reference signals, where transmitting the one or more aperiodic sounding reference signals during the second available transmission time interval may be based on the determining.

Some examples of the method, apparatuses, and non-transitory computer-readable medium described herein may further include operations, features, means, or instructions for receiving, in the second radio resource control message, an instruction to use the slot offset value indicating the second available transmission time interval, where transmitting the one or more aperiodic sounding reference signals during the second available transmission time interval may be based on receiving the instruction.

Some examples of the method, apparatuses, and non-transitory computer-readable medium described herein may further include operations, features, means, or instructions for identifying a format of the second downlink control information message, a core resource set associated with the second downlink control information message, a synchronization signal associated with the second downlink control information message, or any combination thereof, where transmitting the one or more aperiodic sounding reference signals during the second available transmission time interval may be based on the identifying.

Some examples of the method, apparatuses, and non-transitory computer-readable medium described herein may further include operations, features, means, or instructions for receiving, from the base station, a second radio resource control message including a second indication of one or more available transmission time intervals for transmitting aperiodic sounding reference signals, receiving, from the base station, a second downlink control information message triggering a transmission of one or more aperiodic sounding reference signals on a second sounding reference signal resource set, where the first downlink control information message may be a scheduling downlink control information message and the second downlink control information message may be a non-scheduling downlink control information message including an indication of a second available transmission time interval, and transmitting, to the base station during the second available transmission time interval, the one or more aperiodic sounding reference signals on the second sounding reference signal resource set, where the transmitting during the second available transmission time interval may be based on the indication of the second available transmission time interval.

Some examples of the method, apparatuses, and non-transitory computer-readable medium described herein may further include operations, features, means, or instructions for identifying a third available transmission time interval based on a second code point of the second downlink control information message and the second indication of the one or more available transmission time intervals and prioritizing the second available transmission time interval based on the second downlink control information message being a non-scheduling downlink control information message.

Some examples of the method, apparatuses, and non-transitory computer-readable medium described herein may further include operations, features, means, or instructions for receiving, in the second downlink control information message, an aperiodic sounding reference signal trigger including a second code point, where the second code point includes a first bit of the aperiodic sounding reference signal trigger indicating the second available transmission time interval for non-scheduling downlink control information messages and a second bit of the aperiodic sounding reference signal trigger indicating a third available transmission time interval for scheduling downlink control information messages and prioritizing the second available transmission time interval based on receiving the second downlink control information message.

A method for wireless communications at a base station is described. The method may include transmitting, to a UE, a radio resource control message including an indication of one or more available transmission time intervals for transmitting aperiodic sounding reference signals, transmitting, to the UE, a first downlink control information message triggering a transmission of one or more aperiodic sounding reference signals on a sounding reference signal resource set, and receiving, from the UE during a first available transmission time interval, the one or more aperiodic sounding reference signals on the sounding reference signal resource set, where the receiving during the first available transmission time interval is based on a first code point of the first downlink control information message and the indication of the one or more available transmission time intervals.

An apparatus for wireless communications at a base station is described. The apparatus may include a processor, memory in electronic communication with the processor, and instructions stored in the memory. The instructions may be executable by the processor to cause the apparatus to transmit, to a UE, a radio resource control message including an indication of one or more available transmission time intervals for transmitting aperiodic sounding reference signals, transmit, to the UE, a first downlink control information message triggering a transmission of one or more aperiodic sounding reference signals on a sounding reference signal resource set, and receive, from the UE during a first available transmission time interval, the one or more aperiodic sounding reference signals on the sounding reference signal resource set, where the receiving during the first available transmission time interval is based on a first code point of the first downlink control information message and the indication of the one or more available transmission time intervals.

Another apparatus for wireless communications at a base station is described. The apparatus may include means for transmitting, to a UE, a radio resource control message including an indication of one or more available transmission time intervals for transmitting aperiodic sounding reference signals, means for transmitting, to the UE, a first downlink control information message triggering a transmission of one or more aperiodic sounding reference signals on a sounding reference signal resource set, and means for receiving, from the UE during a first available transmission time interval, the one or more aperiodic sounding reference signals on the sounding reference signal resource set, where the receiving during the first available transmission time interval is based on a first code point of the first downlink control information message and the indication of the one or more available transmission time intervals.

A non-transitory computer-readable medium storing code for wireless communications at a base station is described. The code may include instructions executable by a processor to transmit, to a UE, a radio resource control message including an indication of one or more available transmission time intervals for transmitting aperiodic sounding reference signals, transmit, to the UE, a first downlink control information message triggering a transmission of one or more aperiodic sounding reference signals on a sounding reference signal resource set, and receive, from the UE during a first available transmission time interval, the one or more aperiodic sounding reference signals on the sounding reference signal resource set, where the receiving during the first available transmission time interval is based on a first code point of the first downlink control information message and the indication of the one or more available transmission time intervals.

In some examples of the method, apparatuses, and non-transitory computer-readable medium described herein, the indication of the one or more available transmission time intervals may include operations, features, means, or instructions for an indication of a set of multiple available transmission time intervals, each available transmission time interval of a set of available transmission time intervals corresponding to a respective code point of a set of codepoints including the first code point of the first downlink control information message.

In some examples of the method, apparatuses, and non-transitory computer-readable medium described herein, the indication of the one or more available transmission time intervals may include operations, features, means, or instructions for an indication of a single available transmission time interval, where a set of offset values from the single available transmission time interval correspond to respective code points of a set of codepoints including the first code point of the first downlink control information message.

Some examples of the method, apparatuses, and non-transitory computer-readable medium described herein may further include operations, features, means, or instructions for adding a first offset value of the set of offset values to the single available transmission time interval, the first offset value corresponding to the first code point; and identifying, based on the adding, the first available transmission time interval.

In some examples of the method, apparatuses, and non-transitory computer-readable medium described herein, the indication of the one or more available transmission time intervals may include operations, features, means, or instructions for an indication of the first available transmission time interval and a second available transmission time interval.

Some examples of the method, apparatuses, and non-transitory computer-readable medium described herein may further include operations, features, means, or instructions for transmitting, in the first downlink control information message, an aperiodic sounding reference signal trigger including the first code point, where the first code point includes a first bit of the aperiodic sounding reference signal trigger indicating a first sounding reference signal configuration and a second bit of the aperiodic sounding reference signal trigger indicating the first available transmission time interval.

Some examples of the method, apparatuses, and non-transitory computer-readable medium described herein may further include operations, features, means, or instructions for transmitting, to the UE, a control message including an indication of one or more updated available transmission time intervals for transmitting aperiodic sounding reference signals, one or more updated values for a set of code points including the first code point, or any combination thereof.

In some examples of the method, apparatuses, and non-transitory computer-readable medium described herein, the control message includes a MAC control element (CE).

In some examples of the method, apparatuses, and non-transitory computer-readable medium described herein, the indication of one or more updated available transmission time intervals or transmitting aperiodic sounding reference signals may include operations, features, means, or instructions for an instruction to add or remove one or more entries in a table indicating the available transmission time intervals, or an instruction to enable or disable one or more entries in a table indicating the available transmission time intervals, or both.

In some examples of the method, apparatuses, and non-transitory computer-readable medium described herein, the indication of one or more updated values for the set of code points may include operations, features, means, or instructions for an instruction to add or remove one or more code points of the set of code points, or an instruction to enable or disable one or more code points of the set of code points, or both.

In some examples of the method, apparatuses, and non-transitory computer-readable medium described herein, the MAC-CE includes an instruction to modify a mapping between the set of code points and the available transmission time intervals.

Some examples of the method, apparatuses, and non-transitory computer-readable medium described herein may further include operations, features, means, or instructions for transmitting, to the UE, a second radio resource control message including a slot offset value indicating a second available transmission time interval for transmitting aperiodic sounding reference signals, transmitting, to the UE, a second downlink control information message triggering a transmission of one or more aperiodic sounding reference signals on a second sounding reference signal resource set, and receiving, from the UE during the second available transmission time interval, the one or more aperiodic sounding reference signals on the second sounding reference signal resource set, where the receiving during the second available transmission time interval may be based on determining that one or more sounding reference signal configuration conditions may be satisfied.

Some examples of the method, apparatuses, and non-transitory computer-readable medium described herein may further include operations, features, means, or instructions for determining that the second radio resource control message does not include the indication of the one or more available transmission time intervals for transmitting aperiodic sounding reference signals, where receiving the one or more aperiodic sounding reference signals during the second available transmission time interval may be based on the determining.

Some examples of the method, apparatuses, and non-transitory computer-readable medium described herein may further include operations, features, means, or instructions for transmitting, in the second radio resource control message, an instruction to use the slot offset value indicating the second available transmission time interval, where receiving the one or more aperiodic sounding reference signals during the second available transmission time interval may be based on transmitting the instruction.

Some examples of the method, apparatuses, and non-transitory computer-readable medium described herein may further include operations, features, means, or instructions for identifying a format of the second downlink control information message, a core resource set associated with the second downlink control information message, a synchronization signal associated with the second downlink control information message, or any combination thereof, where receiving the one or more aperiodic sounding reference signals during the second available transmission time interval may be based on the identifying.

Some examples of the method, apparatuses, and non-transitory computer-readable medium described herein may further include operations, features, means, or instructions for transmitting, to the base station, a second radio resource control message including a second indication of one or more available transmission time intervals for transmitting aperiodic sounding reference signals, transmitting, to the UE, a second downlink control information message triggering a transmission of one or more aperiodic sounding reference signals on a second sounding reference signal resource set, where the first downlink control information message may be a scheduling downlink control information message and the second downlink control information message may be a non-scheduling downlink control information message including an indication of a second available transmission time interval, and receiving, from the UE during the second available transmission time interval, the one or more aperiodic sounding reference signals on the second sounding reference signal resource set, where the receiving during the second available transmission time interval may be based on the indication of the second available transmission time interval.

Some examples of the method, apparatuses, and non-transitory computer-readable medium described herein may further include operations, features, means, or instructions for identifying a third available transmission time interval based on a second code point of the second downlink control information message and the second indication of the one or more available transmission time intervals and prioritizing the second available transmission time interval based on the second downlink control information message being a non-scheduling downlink control information message.

Some examples of the method, apparatuses, and non-transitory computer-readable medium described herein may further include operations, features, means, or instructions for transmitting, in the second downlink control information message, an aperiodic sounding reference signal trigger including a second code point, where the second code point includes a first bit of the aperiodic sounding reference signal trigger indicating the second available transmission time interval for non-scheduling downlink control information messages and a second bit of the aperiodic sounding reference signal trigger indicating a third available transmission time interval for scheduling downlink control information messages and prioritizing the second available transmission time interval based on receiving the second downlink control information message.

### BRIEF DESCRIPTION OF THE DRAWINGS

FIG. 1 illustrates an example of a wireless communications system that supports flexible aperiodic sounding reference signal triggering in accordance with aspects of the present disclosure.

FIG. 2 illustrates an example of a wireless communications system that supports flexible aperiodic sounding reference signal triggering in accordance with aspects of the present disclosure.

FIG. 3 illustrates an example of a timeline that supports flexible aperiodic sounding reference signal triggering in accordance with aspects of the present disclosure.

FIG. 4 illustrates an example of a process flow that supports flexible aperiodic sounding reference signal triggering in accordance with aspects of the present disclosure.

FIG. 5 illustrates an example of a control message that supports flexible aperiodic sounding reference signal triggering in accordance with aspects of the present disclosure.

FIGS. 6 and 7 show diagrams of devices that support flexible aperiodic sounding reference signal triggering in accordance with aspects of the present disclosure.

FIG. 8 shows a diagram of a communications manager that supports flexible aperiodic sounding reference signal triggering in accordance with aspects of the present disclosure.

FIG. 9 shows a diagram of a system including a device that supports flexible aperiodic sounding reference signal triggering in accordance with aspects of the present disclosure.

FIGS. 10 and 11 show diagrams of devices that support flexible aperiodic sounding reference signal triggering in accordance with aspects of the present disclosure.

FIG. 12 shows a diagram of a communications manager that supports flexible aperiodic sounding reference signal triggering in accordance with aspects of the present disclosure.

FIG. 13 shows a diagram of a system including a device that supports flexible aperiodic sounding reference signal triggering in accordance with aspects of the present disclosure.

FIGS. 14 through 18 show flowcharts illustrating methods that support flexible aperiodic sounding reference signal triggering in accordance with aspects of the present disclosure.

### DETAILED DESCRIPTION

Some wireless communications systems may support aperiodic sounding reference signal (SRS) transmissions. A base station may transmit a radio resource control (RRC) message indicating a static slot offset value. The UE may transmit aperiodic SRSs a number of transmission time intervals (TTIs) (e.g., the indicated slot offset value) after receiving a grant (e.g., in a downlink control information (DCI) message) triggering SRS transmissions. However, such schemes may lack flexibility for assigning a different slot for different SRS resource sets, or may be associated with costly overhead. For example, additional DCI code points for each SRS resource set may indicate an offset. However, DCI fields are limited, and such additional DCI code points may result in decreased effectiveness of the DCI field. In some examples, such extra bits may be added to a DCI, resulting in increased DCI size and degraded physical downlink control channel (PDCCH) reception because of DCI overhead.

A base station may transmit an RRC message to a UE including an RRC parameter that indicates a set of values for different available slots (e.g., an AvailableSlotList RRC parameter). The base station may transmit a DCI that triggers aperiodic SRS transmissions. The trigger may include a two-bit indicator, and the UE may interpret a code point of the two-bit indicator to implicitly indicate one of the available slots listed in the RRC parameter. The UE may identify the available slot based on a 1:1 mapping between code points of the trigger and the values for different available slots, or the RRC parameter may indicate a single value and each code point of the trigger may correspond to offset values that can be added to the single value, or the like. In some examples, the base station may indicate the available slot using a bit-split scheme (e.g., one bit indicating a configuration/type, and one bit indicating one of two available slots). The base station may transmit a media access control (MAC) control element (CE) MAC-CE using a new format to dynamically update the available slots of the available slot list, other RRC configured values, or the DCI code points, or any combination thereof.

Techniques described herein may be implemented to realize one or more advantages. For example, devices in a wireless communications system may be able to more flexibly, and therefore more efficiently, schedule aperiodic SRS transmissions, resulting in increased system efficiency, efficient use of available resources, decreased system congestion, decreased system latency, and the like. Additionally, such techniques may be implemented without sacrificing size and efficiency of DCI signaling and decoding, or increasing overhead. In some examples, techniques described herein may be backwards compatible, resulting in the advantages described herein in without introducing compatibility issues between devices of different capabilities or generations.

Aspects of the disclosure are initially described in the context of wireless communications systems. Aspects of the disclosure are further illustrated by and described with reference to timelines, process flows, and control messages. Aspects of the disclosure are further illustrated by and described with reference to apparatus diagrams, system diagrams, and flowcharts that relate to flexible aperiodic sounding reference signal triggering.

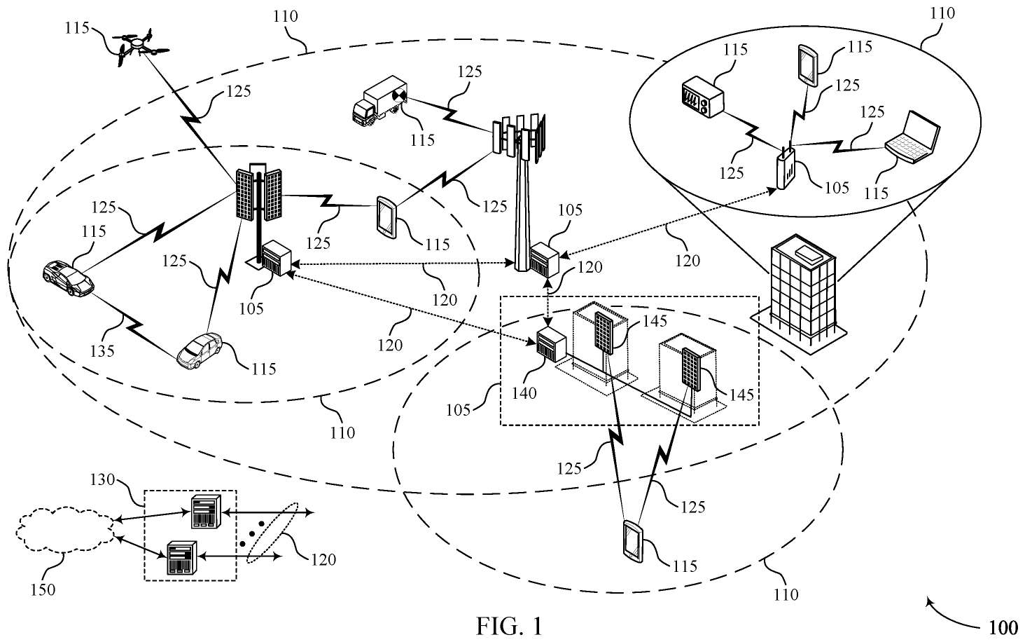

FIG. 1 illustrates an example of a wireless communications system 100 that supports flexible aperiodic sounding reference signal triggering in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally, or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the Radio Resource Control (RRC) protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

A base station 105 may transmit an RRC message to a UE including an RRC parameter that indicates a set of values for different available slots (e.g., an AvailableSlotList RRC parameter). The base station 105 may transmit a DCI that triggers aperiodic SRS transmissions. The trigger may include a two-bit indicator, and the UE 115 may interpret a code point of the two-bit indicator to implicitly indicate one of the available slots listed in the RRC parameter. The UE 115 may identify the available slot based on a 1:1 mapping between code points of the trigger and the values for different available slots, or the RRC parameter may indicate a single value and each code point of the trigger may correspond to offset values that can be added to the single value, or the like. In some examples, the base station may indicate the available slot using a bit-split scheme (e.g., one bit indicating a configuration/type, and one bit indicating one of two available slots). The base station 105 may transmit a MAC-CE using a new format to dynamically update the available slots of the available slot list, other RRC configured values, or the DCI code points, or any combination thereof.

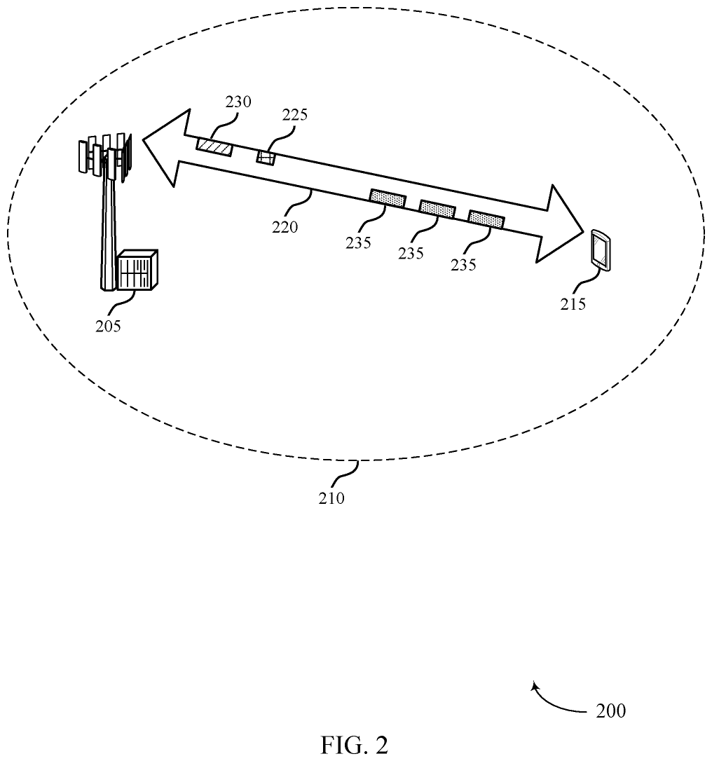

FIG. 2 illustrates an example of a wireless communications system 200 that supports flexible aperiodic sounding reference signal triggering in accordance with aspects of the present disclosure. Wireless communications system 200 may include a base station 205 and a UE 215, which may be examples of corresponding devices described with reference to FIG. 1. The base station 205 may serve one or more UEs 215 located within a coverage area 210.

Base station 205 may communicate with UE 215 via bidirectional communication link 220. In some examples, base station 205 may trigger uplink transmission of one or more aperiodic SRSs 235. UE 215 may transmit the aperiodic SRSs 235 based on configuration information (e.g., RRC signaling) and a triggering DCI 225. For example, base station 205 may transmit RRC message 230. RRC message 230 may include one or more RRC parameters (e.g., a slotOffset parameter) indicating an offset between receiving DCI 225 and transmitting SRSs 235. For instance, the offset may be some value between 9 and 32 TTIs. Base station 205 may transmit a triggering DCI 225 to UE 215. The triggering DCI may include an indication (e.g., a two-bit trigger or SRS request value). The trigger (e.g., an SRS-ResourceTrigger value) may indicate one or more SRS resource sets, one or more sets of serving cells or carriers configured by higher layer signaling, or a combination thereof. For instance, DCI 225 may include an SRS request field including a two-bit indicator or trigger. If the indicator is set to 0 (e.g., 00), then the UE may determine that no aperiodic SRS resource set is triggered. If the indicator is set to 1 (e.g., 01), then UE 215 may determine that one or more SRS resource sets are configured for a first set of one or more serving cells. Similarly, if the indicator is set to 2 (e.g., 10), then UE 215 may determine that one or more SRS resource sets are configured for a second set of one or more serving cells. If the indicator is set to 3 (e.g., 11), then UE 215 may determine that one or more SRS resource sets are configured for a third set of one or more serving cells. Each SRS resource of an SRS resource set may have an associated symbol index of a first symbol containing the SRS resources (e.g., a start position) within a particular TTI (e.g., after the offset).

Thus UE 215 may determine time and frequency resources within a TTI for transmitting SRSs 235 according to an indicated SRS resource set (e.g., including a start position within a TTI) based at least in part on receiving the triggering DCI 225, and may determine the TTI in which to initiate transmission of the SRSs 235 on the SRS resource set (e.g., which may span multiple consecutive OFDM symbols) based on the RRC message 230 (e.g., the offset value indicated in the RRC message 230). In some examples, a DCI format 0_1 may schedule communications on a physical uplink shared channel (PUSCH) in one cell. Such a DCI may include an SRS request (e.g., the two-bit indicator triggering the aperiodic SRS transmissions). Similarly, in some examples, a DCI format 1_1 may schedule communications on a physical downlink shared channel (PDSCH) in one cell. Such a DCI may also include an SRS request (e.g., the two-bit indicator triggering the aperiodic SRS transmissions). However, identifying a timing for transmitting SRSs 235 based on an offset indicated in an RRC message 230 may be inflexible, resulting in inefficient use of resources, increased delays, or the like.

In some examples, base station 205 may more flexibly indicate aperiodic SRS slot offsets using dynamic signaling. For instance, each SRS resource set may be configured with a list of slot offsets, where each code point in the DCI is associated with a particular offset value in the list. Or, one slot offset list may be configured for all SRS resource sets, and each code point in the DCI may be associated with a particular offset value in the list. The indication of code points may reuse existing DCI fields to indicate slot-offsets for different SRS resource sets, or new DCI fields may be added to indicate the slot offsets. However, repurposing legacy DCI fields may be expensive in terms of signaling overhead, and DCI formats may include a limited number of fields so that repurposing any of them may impact encoding, decoding, or may otherwise decrease performance. Additionally, in some examples, a single SRS code point may trigger multiple SRS resource sets, and for each SRS resource set a DCI code point may be needed in such techniques to indicate an offset value. Thus, repurposing legacy DCI fields for such dynamic explicit signaling may result in increased overhead in DCI signaling. Additionally, adding new DCI fields may result in decreased decoding performance and degraded PDCCH and PDSCH reception because of DCI overhead, failed transmissions, or the like.

In some examples, base station 205 may implicitly indicate dynamic offset values for transmitting SRSs 235 without repurposing DCI fields or increasing DCI overhead. Instead, a new RRC parameter (e.g., AvailableSlotList) may indicate multiple values for available TTIs in which to transmit the aperiodic SRSs 235. UE 215 may interpret the aperiodic SRS trigger (e.g., the two-bit SRS resource request) in DCI 225 as indicating one of the available TTIs indicated in the new RRC parameter. Thus, base station 205 may dynamically indicate different offsets (e.g., different available TTIs in which to start transmitting SRSs 235 on indicated SRS resource sets) without repurposing existing DCI fields or adding new DCI fields.

In some examples, base station 205 may configure UE 215 (e.g., via RRC signaling) with an SRS request table. The SRS table may indicate a value of an SRS request field (e.g., an SRS trigger). The values for the SRS request field may trigger aperiodic SRSs 235, may indicate one or more SRS resource sets configured with a higher layer parameter aperiodicSRS-ResourceTrigger set to a value matching the SRS request code point, or an entry in a higher layer parameter aperiodicSRS-ResourceTriggerList set to a value matching the SRS request code point.

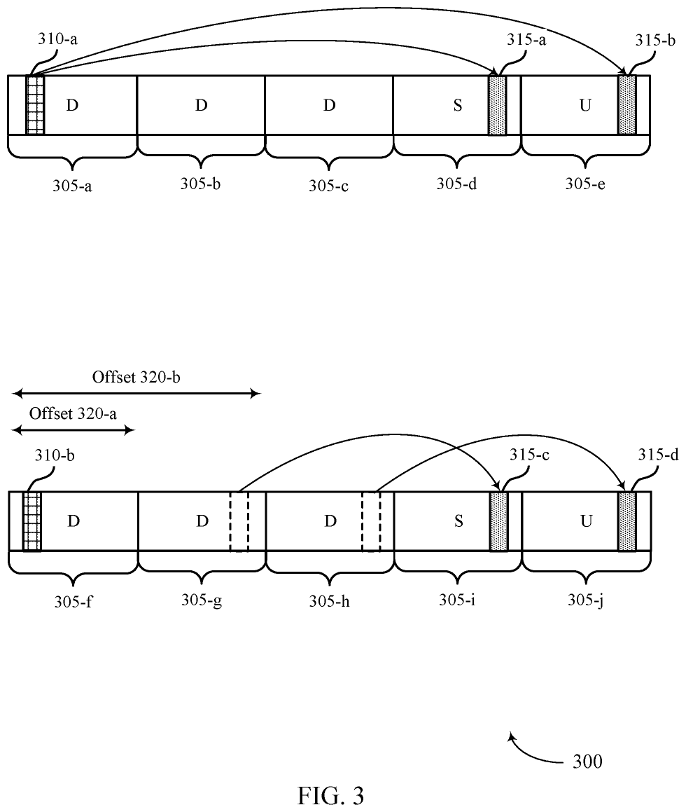

In some examples, UE 215 may determine an available slot for transmitting the aperiodic SRSs 235 based on a reference slot, as described in greater detail with reference to FIG. 3.

FIG. 3 illustrates an example of a timeline 300 that supports flexible aperiodic sounding reference signal triggering in accordance with aspects of the present disclosure. Timeline 300 may support communications between a base station 205 and one or more UEs 215, which may be examples of corresponding devices described with reference to FIGS. 1 and 2.

UE 215 may receive a DCI 310 from base station 205, and may then determine when to transmit triggered aperiodic SRSs 315. In some examples, UE 215 may transmit an aperiodic SRS resource set in the (t+1)-th available slot counting from a reference slot. The value oft may be indicated via higher layer signaling (e.g., RRC signaling), included in the DCI 310, or any combination thereof. For instance, a single value oft may be indicated in an RRC message, or multiple candidate values for t may be indicated in an RRC message, and base station 205 may indicate one of the candidate values for tin a DCI 310. Candidate values oft may at least include 0.

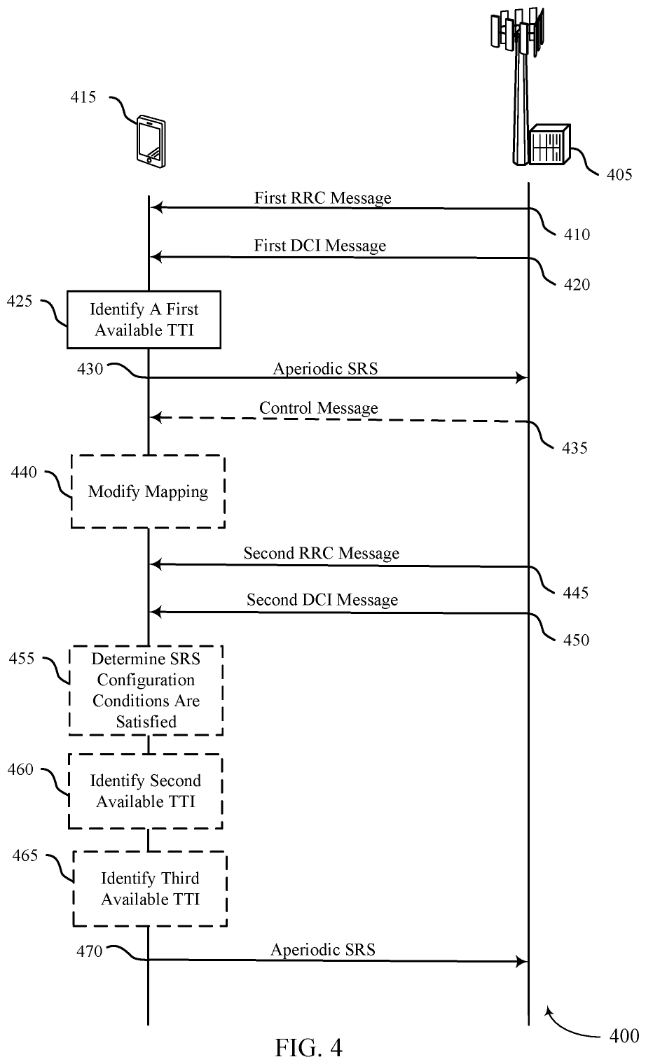

In some examples, the reference slot may be the slot 305 in which UE 215 receives DCI 310-a. For example, DCI 310-a may trigger two aperiodic SRS resource sets 315 (e.g., aperiodic SRS resource set 315-a and aperiodic SRS resource set 315-b). Base station 205 may indicate (e.g., via RRC message, DCI 310-a, or both) that t=0 for aperiodic SRS resource set 315-a, and that t=1 for aperiodic SRS resource set 315-b. The value of t may represent an available slot 305. Based on the indication of values for t, UE 215 may identify a first (e.g., next) available slot 305 for transmitting aperiodic SRS resource set 315-a, and a second available slot 305 for transmitting aperiodic SRS resource set 315-b. Slot 305-a, slot 305-b and slot 305-c may be downlink slots, slot 305-d may be designate as a special slot with both uplink and downlink symbols available, and slot 305-e may be an uplink slot. In such examples, where the reference slot is slot 305-a in which UE 215 received DCI 310-a, UE 215 may determine that the first available slot 305 is slot 305-d (e.g., the first slot 305 after slot 305-a in which uplink transmission of SRSs is possible) and may determine that the second available slot 305 is slot 305-e (e.g., the second slot 305 after the reference slot (slot 305-a) and the first available slot 305-d). In such examples, UE 215 may transmit aperiodic SRSs on aperiodic SRS resource set 315-a during slot 305-d, and may transmit aperiodic SRSs on aperiodic SRS resource set 315-b during slot 305-e. Transmission of the aperiodic SRSs during the correct time may be based on successfully identifying an offset from the reference slot 305-a to the next available slots based on signaling form base station 205, as described in greater detail with reference to FIG. 4.

In some examples, the reference slot may be the slot 305 indicated by an RRC message (e.g., RRC slotOffset parameter). For example, base station 205 may indicate, in an RRC message, one or more slot offset values (e.g., 1 slot, 2 slots, etc.). Base station 205 may indicate (e.g., via RRC message, DCI 310-a, or both) that t=0 for aperiodic SRS resource set 315-a, and that t=1 for aperiodic SRS resource set 315-b. The value oft may represent an available slot 305. Based on the indication of values for t, UE 215 may identify a first (e.g., next) available slot 305 for transmitting aperiodic SRS resource set 315-c, and a second available slot 305 for transmitting aperiodic SRS resource set 315-d. Slot 305-f, slot 305-g. and slot 305-h may be downlink slots, slot 305-i may be designate as a special slot with both uplink and downlink symbols available, and slot 305-j may be an uplink slot. In such examples, the offset value may be offset 320-a (e.g., 1 slot), and the reference slot may therefore be slot 305-g. That is, UE 215 may receive DCI 310-b in slot 305-f, may apply the offset 320-a to slot 305-f, resulting in a reference slot 305-g. From reference slot 305-g, UE 215 may identify the next available slot 305-i (e.g., based on t=0) after reference slot 305-g. UE 215 may also determine that the second available slot 305 is slot 305-j (e.g., the second available slot 305 after the reference slot (slot 305-g) and the first available slot 305-i). Similarly, if the offset value indicates offset 320-b (e.g., 2 slots), the reference slot may be slot 305-h (e.g., 2 slots after slot 305-f in which UE 215 receives DCI 310-b). UE 215 may transmit aperiodic SRSs on aperiodic SRS resource set 315-c during slot 305-i, and may transmit aperiodic SRSs on aperiodic SRS resource set 315-j during slot 305-j. Transmission of the aperiodic SRSs during the correct time may be based on successfully identifying an offset from the reference slot 305-g or reference slot 305-h to the next available slots 305 based on signaling form base station 205, as described in greater detail with reference to FIG. 4.

In some examples, available slots 305 (e.g., whether the reference slot is the slot in which DCI 310 is received or a slot offset from the slot in which DCI 310 is received) may be defined based on UE processing complexity, signaling timeline, or the like, to determine available slots, potential co=existence with collision handling, etc. In some examples, base station 205 may indicate (e.g., via a new RRC parameter, such as AvailableSlotList) a set of available slots that satisfy one or more conditions. For instance, an available slot indicated in such an RRC parameter may be a slot that includes uplink or flexible symbols for time-domain locations for all SRS resources in an indicated resource set, may satisfy a minimum timing requirement between triggering PDCCH and all SRS resources in the SRS resource set, or the like.

In some examples, UE 215 may rely on implicit indications of available slots in which to transmit aperiodic SRS resource sets. For example, UE 215 may interpret a code point of an SRS trigger (e.g., an aperiodic SRS resource request in a triggering DCI 310) as indicating or being associated with a value from a list of available slots configured via higher layer signaling, as described in greater detail with reference to FIG. 4.

FIG. 4 illustrates an example of a process flow 400 that supports flexible aperiodic sounding reference signal triggering in accordance with aspects of the present disclosure. Process flow 400 may include one or more UEs 415 which may be examples of corresponding devices (e.g., UEs 115 or UEs 215) as described with reference to FIGS. 1 and 2. Further, process flow 400 may include one or more base stations 405 which may be examples of corresponding devices described with reference to FIGS. 1 and 2. In some examples, techniques described herein may support implicit indications of available slots (e.g., an implicit indication, based on interpretation of an aperiodic resource trigger, of an available slot in which to transmit aperiodic SRSs). Techniques described herein may also define a MAC-CE payload for updating, enabling, or disabling candidate available slots (e.g., entries in a table indicating a set of available TTIs configured in an RRC message). Techniques described herein may describe legacy-compatible SRS triggering, as well as procedures for available TTI determination based on a DCI format (e.g., formatting for scheduling DCIs and for non-scheduling DCIs).

At 410, the base station 405 may transmit a first RRC message. The first RRC message may include an indication of one or more available TTIs (e.g., slots) for transmitting aperiodic SRSs. The first RRC message may include a parameter (e.g., AvailableSlotList) indicating the one or more available TTIs. At 420, base station 405 may transmit a first DCI message, triggering the aperiodic SRSs and indicating an available slot from the available slot list. For example, an SRS trigger (e.g., an SRS request field in the first DCI message) may include a code point indicating one or more SRS resource sets for transmitting the aperiodic SRSs. UE 415 may interpret the code point of the SRS request (e.g., a two-bit SRS trigger) as indicating an available TTI from a list of available TTIs included in the first RRC message.

The first RRC message may include a table indicating various code points of an SRS request field (e.g., an SRS trigger) included in subsequent DCIs (e.g., the first DCI). The SRS request field in DCI 420 may trigger transmission of aperiodic SRSs at 430, and the table indicated in the first RRC message may indicate a relationship between different code points of the SRS request field in DCI and respective values for the list of available slots. In some examples, one or more RRC messages may configure a table indicating a correspondence between code points of the SRS request and one or more SRS resource sets configured with a higher layer parameter aperiodicSRS-ResourceTrigger, or higher layer parameter aperiodicSRS-ResourceTriggerList.

In some examples, the first RRC message may indicate a set of multiple available TTIs for transmitting aperiodic SRSs. In such examples, each entry in the list of available TTIs may be mapped to a corresponding SRS trigger code point (e.g., a trigger codepoint in an aperiodicSRS-ResourceTriggerList parameter). In some examples, the values for the list of available TTIs (e.g., values for an AvailableSlotList parameter) may be equal to a number of values established by another RRC parameter (e.g., from 1 to a maximum value of aperiodicSRS0TriggerStates). Thus, the number of available code points for the SRS request (e.g., based on the number of configured values for aperiodicSRS-ResourceTriggerList parameter) may be equal to and mapped at a 1:1 ratio to the number of available slots indicated in the first RRC message. In such examples, a first code point (e.g., 01) may indicate a first available TTI (e.g., available slot 0), a second code point (e.g., 10) may indicate a second available TTI (e.g., available slot 1), and a third code point (e.g., 11) may indicate a third available TTI.

In some examples, the first RRC message may indicate a single value (e.g. indicating a single available TTI, or a reference TTI, or the like). If no value is indicated, then UE 415 may determine that the value is 0 (e.g., the slot in which UE 415 receives the DCI is a reference TTI from which offsets may be determined). For each value of an RRC parameter (e.g., for each SRS trigger code point), UE 415 may determine an available slot for transmitting the aperiodic SRSs based on the sum of the configured available TTI value and the value of the SRS trigger. For example, for each SRS trigger code point, UE 415 may identify an associated available TTI by adding a different value or offset to the single value indicated in the first RRC message. For instance, the first RRC message may indicate a single value k0 (e.g., a number of TTIs, a time offset in ms, or the like). For a first code point (e.g., 01), UE 415 may determine to initiate transmission of the aperiodic SRS in a first available TTI (e.g., k0+1), for a second code point (e.g., 10), UE 415 may determine to initiate transmission of the aperiodic SRS in a second available TTI (e.g., k0+2), and for a third code point (e.g., 11), UE 415 may determine to initiate transmission of the aperiodic SRS in a third available TTI (e.g., k0+1).

In some examples, base station 405 may configure UE 415 with one or more parameters (e.g., aperiodicSRS-ResourceTriggerList), but the number of values for the parameter (e.g., the triggering code points) may not be equal to the number of values (e.g., the length) of the available TTIs (e.g., AvailableSlotList). In such examples, UE 415 may assume that a value for an available TTI (e.g., a single entry in AvailableSlotList, if the available TTIs list only includes a single value) is to be used for each code point. Alternatively, UE 415 may assume that each value for an available TTI is associated with a code point, a code point plus an offset value, or both. For instance, for a first code point (e.g., 01), UE 415 may determine a first available TTI (e.g., delta offset 1), for a second code point (e.g., 10), UE 415 may determine a second available TTI (e.g., delta offset 2), and for a third code point (e.g., 11), UE 415 may determine a third available TTI (e.g., delta offset 3).

In some examples, different bits of the SRS trigger may indicate different information (e.g. a bit-split scheme). Base station 405 may limit the triggering values to only 2 (e.g., instead of 3). The list of available slots may similarly be limited to only 2 values. One bit of the SRS trigger may indicate a value for a first configuration of SRS resource sets, or the like (e.g., a first value for the RRC parameter AperiodicSRS-ResourceTriggerList). Another bit of the SRS trigger may indicate which of the 2 available TTIs are to be used for transmitting the triggered aperiodic SRSs. For example, a first code point of the SRS trigger (e.g., 00) may indicate one or more SRS resource sets with AperiodicSRS-ResourceTrigger set to 1, and selection of a first available TTI from the list of available TTIs. A second code point of the SRS trigger (e.g., 01) may indicate one or more SRS resource sets with AperiodicSRS-ResourceTrigger set to 1, and selection of a second. available slot from the list of available slots. A third code point of the SRS trigger (e.g., 10) may indicate one or more SRS resource sets with AperiodicSRS-ResourceTrigger set to 2, and selection of the first available slot from the list of available slots. A fourth code point of the SRS trigger (e.g., 11) may indicate one or more SRS resource sets with AperiodicSRS-ResourceTrigger set to 2, and selection of the second available slot from the list of available slots.

At 425, UE 415 may identify the first available TTI for transmitting the SRSs triggered at 420. UE 415 may identify the first available TTI based on the techniques described herein. For example, UE 415 may identify an available TTI of a list of TTIs indicated in the first RRC message at 410 that is mapped to a code point of the SRS trigger received in the first DCI message at 420. Or, UE 415 may identify a single available TTI indicated in the first RRC message at 410, and may apply an offset indicated by the code point of the SRS trigger to the single available TTI. Or, UE 415 may utilize a bit-split scheme, or any other combination of the RRC message and the DCI message, as described herein, to identify a first available TTI from the list of available TTIs.

At 430, UE 415 may transmit the aperiodic SRSs on an SRS resource set indicated by the first DCI message, in the available TTI identified at 425.

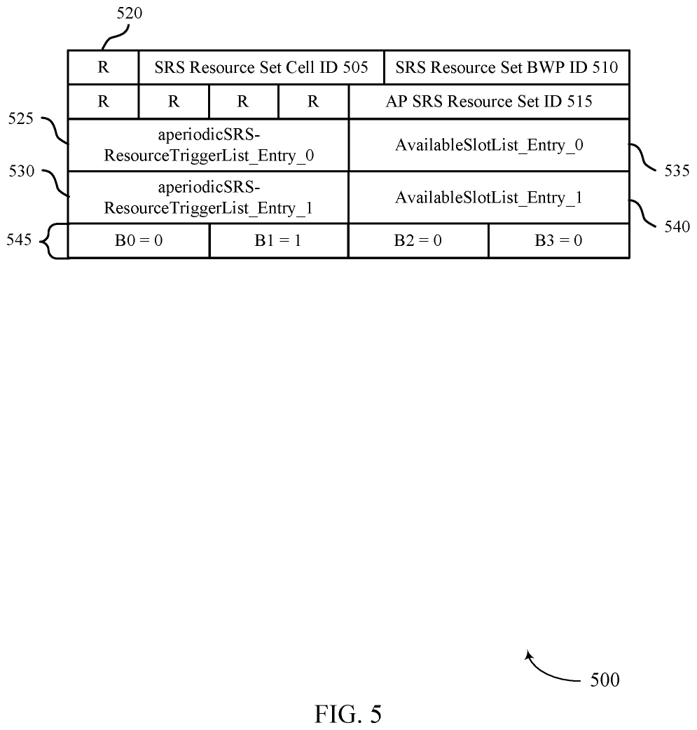

In some examples, base station 405 may dynamically update the available TTIs indicated in the first RRC message, one or more code points (e.g., values for the aperiodicSRS-ResourceTriggerList parameter), or any combination thereof. For example, at 435, base station 405 may transmit a control message to UE 415. The control message may be a MAC-CE, as described in greater detail with reference to FIG. 5. The MAC-CE payload may include a command to update the list of available TTIS (e.g., entries in the AvailableSlotList), the available code points (e.g., entries in the aperiodicSRS-ResourceTriggerList), or any combination thereof. The MAC-CE may include instructions to add entries to either list, delete entries from either list, activate or enable entries from either list, deactivate or disable entries from either list, or any combination thereof. In some examples, the MAC-CE may include an updated mapping of code points to available TTIs. Such MAC-CEs may include commands as described herein per-BWP update.

At 440, UE 415 may modify a mapping between the code points and the available TTIs (e.g., may add, delete, enable, or disable one or more values, or may adjust a mapping between previously configured values, or any combination thereof). At 445, base station 405 may transmit a second RRC message, which may include an updated list of available TTIs according to the modifications indicated in the control message at 435. At 450, base station 405 may transmit a second DCI, triggering a transmission of aperiodic SRSs. UE 415 may identify an available TTI in which to transmit the aperiodic SRSs based on the second RRC message, the second DCI message, and the modified mapping performed at 440.

In some examples, UE 415 may determine to rely on additional procedure (e.g., legacy techniques) to identify available TTIs in which to transmit SRSs. For instance, at 445 base station 405 may transmit a second RRC message. At 450, base station 405 may transmit, and UE 415 may receive, a second DCI message that triggers transmission of aperiodic SRS at 470. At 455, UE 415 may determine whether one or more SRS configuration condition are satisfied, and may determine an available TTI for transmitting the SRSs based on whether the conditions are satisfied. For instance, UE 415 may determine whether an RRC parameter indicating a list of available TTIs (e.g., AvailableSlotList) is included in the second RRC message. If the RRC parameter is not present in second RRC message 445, then UE 415 may consider a condition satisfied, and may refrain from determining an available TTI based on such an RRC parameter in combination with implicit indications in the second DCI, and may instead rely on legacy SRS triggering (e.g., an RRC parameter such as a SlotOffset parameter included in a previously received RRC message, or otherwise configured at UE 415).

In some examples, considering the one or more conditions satisfied may include receiving an RRC message (e.g., at 445) indicating an SRS resource set level instruction of which triggering technique to use. For instance, such an RRC parameter may be included in the first RRC message received at 410, and the RRC parameter may include an instruction for UE 415 to identify the first available TTI as described at 420 and 425 based on the indication. Such an RRC parameter may be included in the second RRC message received at 445, and may include an instruction for UE 415 to identify a second available SRS TTI at 460 based on a configured offset value (e.g., based on a SlotOffset parameter value instead of relying on an implicit indication in the second DCI message).

In some examples, UE 415 may determine that an SRS configuration condition is satisfied based on a DCI format, a CORESET, a synchronization signal (SS) configuration, or the like. For instance, a first DCI format may be associated with implicit indications described with reference to 420 and 425, a first radio access technology (RAT) (e.g., NR), or the like, while a second DCI format may be associated with explicit signaling, a second RAT (e.g., LTE or other legacy systems), or the like. The first DCI message may be of the first DCI format or may be associated with the first RAT, and the second DCI may be of the second DCI format or associated with the second RAT. If the second DCI is of the second DCI format or the second RAT, etc., then UE 415 may consider the SRS configuration condition satisfied, and may identify the second available TTI based thereon. Similarly, a first CORESET may be associated with implicit signaling of available TTIs while a second CORESET may be associated with explicit or legacy indications of available TTIs. Thus, UE 415 may determine whether to rely on implicit indications of available TTIs or to switch to legacy behavior based on the CORESET associated with the second DCI message. In some examples, a first synchronization signal or synchronization signal block (SSB) may be associated with implicit indications of available TTIs while a second synchronization of SSB may be associated with explicit or legacy indications of available TTIs. Thus, UE 415 may determine whether to rely on implicit indications of available TTIs or to switch to legacy behavior based on the synchronization signals or SSBs associated with the second DCI message.

UE 415 may identify the second available TTI based on determining that one, multiple, or all of the above described conditions are satisfied. At 470, in such examples, UE 415 may transmit the aperiodic SRSs triggered by the second DCI message during the second available TTI.

In some examples, UE 415 may identify available TTIs for transmitting aperiodic SRSs differently for different DCI format types. UE 415 may receive the second DCI message at 450, and the second DCI message may have a different format than the first DCI message. For example, the first DCI message may be a scheduling DCI, including scheduling information for a data transmission on a PUSCH or PDSCH, while second DCI message may not schedule data transmissions. Non-scheduling DCIs may not be subject to the same size and bit limitations as scheduling DCIs. In some examples, the second DCI message may include an explicit indication of available TTIs for transmitting aperiodic SRSs. However, UE 415 may also be capable of interpreting an implicit indication of available TTIs based on the second RRC message (e.g., which may include a list of available TTIs) and an SRS trigger included in the second DCI message.

In some examples, UE 415 may determine an available TTI for transmitting SRSs by prioritizing explicit indications over implicit indications. For example, a code point of an SRS trigger in the second DCI message may correspond to a third available TTI. The second DCI message may also include an explicit indication of the second available TTI. At 460, UE 415 may identify the second available TTI based on the explicit indication, and at 465, UE 415 may identify the third available TTI based on the SRS trigger code point and the second RRC message. UE 415 may determine to prioritize the explicit indication over the implicit indication, and may transmit the aperiodic SRSs in the second available TTI based thereon.

In some examples, base station 405 may configure UE 415 (e.g., via higher layer signaling) with two sets of possible values (e.g., two tables). If the second DCI message does not include an explicit indication of the available TTI, then UE 415 may rely on the first set of values. If the second DCI message does include an explicit indication of the available TTI, then UE 415 may rely on the second set of values to identify the available TTI. In some examples, the second list may be a subset of the first list, or vice versa. In some examples, a first bit of an SRS trigger code point may be designated for explicit indications, and a second bit of the SRS trigger code point may be designated for implicit indications. For instance, a first bit set to 0 may explicitly indicate a first value, and the first bit set to 1 may explicitly indicate a second value. The second bit set to 0 may implicitly indicate a third value, and the second bit set to 1 may implicitly indicate a fourth value. Thus, base station 405 may include, in the second DCI message, an instruction to rely on an explicit indication, in which case, UE 415 may identify the second available TTI based on the first bit. If base station 405 does not include such an explicit indication in the second DCI message, then UE 415 may rely solely on the first second bit to identify the third available TTI. In some examples, both bits may be used to indicate four different available TTIs for implicit indications, while one bit (e.g., the first bit) may be used to indicate one of only two available TTIs for explicit indications.

FIG. 5 illustrates an example of a control message 500 that supports flexible aperiodic sounding reference signal triggering in accordance with aspects of the present disclosure. Control message 500 may be transmitted by a base station and received by one or more UEs, which may be examples of corresponding devices described with reference to FIGS. 1, 2, 3, and 4. In some examples, control message 500 may be a MAC-CE.

The MAC-CE may include one or more fields. For example, the MAC-CE may include a field for SRS Resource set Cell ID 505, indicating a cell ID for the aperiodic SRSs. The MAC-CE may include a field for an SRS resource set bandwidth part (BWP) identifier 510, indicating a BWP for the aperiodic SRS. The MAC-CE may include a field for aperiodic SRS resource set identifier 515, which may indicate an aperiodic SRS resource set. Thus, the MAC-CE may be used to update or modify one or more code points, one or more available TTIs, or both, for a particular BWP. The MAC-CE may also include one or more reserved fields 520.

The MAC-CE may include one or more fields for updating, modifying, deleting, or adding available TTIs values to a list of available TTIs. For instance, field 535 may include a value for a first entry in a list of available slots (e.g., a new or modified value for the AvailableSlotList Entry 0). Similarly, field 540 may include a value for a second entry in the list of available slots (e.g., a new or modified value for the AvailableSlotList Entry 1). The MAC-CE may also include one or more fields for code points. The fields for code points may be associated with the entries in the list of available TTIs, or may also be modified. For instance, field 525 may include a value for a first entry in a list of code point values (e.g., a new or modified value for the aperiodicSRS-ResourceTriggerList Entry 0). Similarly, field 530 may include a value for a second entry in the list of code point values (e.g., a new or modified value for the aperiodicSRS-ResourceTriggerList Entry 1). Thus, MAC-CE may include updated, new, or modified values for the first and second entries in the list of code points, updated, new, or modified values for the first and second entries in the list of available TTIs, or both. In some examples, the MAC-CE may also include one or more values for deletion for either the list of available TTIs or the list of code points.

In some examples, the MAC-CE may enable or disable one or more entries in the list of available code points, or the list of available TTIs. For instance, the MAC-CE may include a bitmap 545 corresponding to entries in the list of available TTIs. If the list of available TTIs includes four entries, then the bit map may include four bits (e.g., B0, B1, B2, and B3). The bits may indicate enabling or disabling of a corresponding entry in the list. For instance, B0 may be set to 0 indicting that a first entry is disabled B1 may be set to 1 indicating that a second entry is enabled, B2 may be set to 0 indicating that a third entry is disabled, and B3 may be set to 0 indicating that a fourth entry is disabled. Thus, MAC-CE may enable or disable one or more entries of a list of available TTIs.

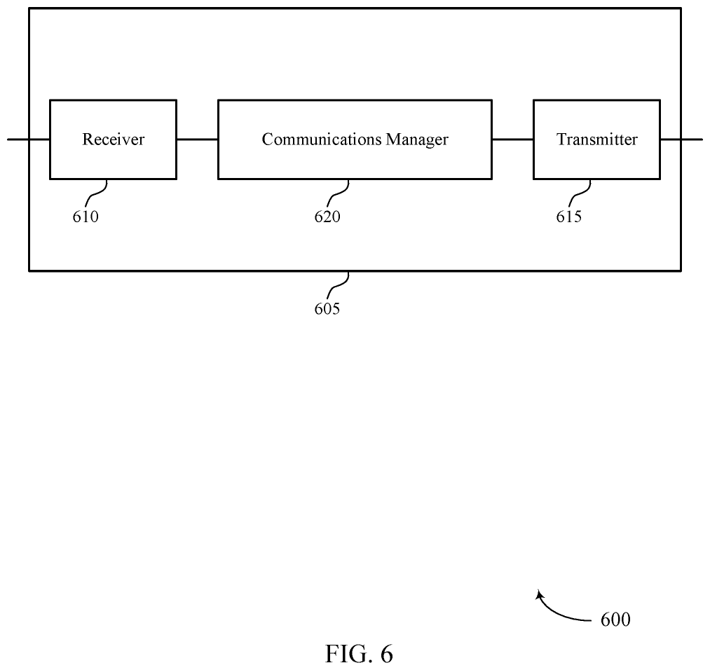

FIG. 6 shows a diagram 600 of a device 605 that supports flexible aperiodic sounding reference signal triggering in accordance with aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to flexible aperiodic sounding reference signal triggering). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to flexible aperiodic sounding reference signal triggering). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of flexible aperiodic sounding reference signal triggering as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 620 may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a UE in accordance with examples as disclosed herein. For example, the communications manager 620 may be configured as or otherwise support a means for receiving, from a base station, a radio resource control message including an indication of one or more available transmission time intervals for transmitting aperiodic sounding reference signals. The communications manager 620 may be configured as or otherwise support a means for receiving, from the base station, a first downlink control information message triggering a transmission of one or more aperiodic sounding reference signals on a sounding reference signal resource set. The communications manager 620 may be configured as or otherwise support a means for transmitting, to the base station during a first available transmission time interval, the one or more aperiodic sounding reference signals on the sounding reference signal resource set, where the transmitting during the first available transmission time interval is based on a first code point of the first downlink control information message and the indication of the one or more available transmission time intervals.

By including or configuring the communications manager 620 in accordance with examples as described herein, the device 605 (e.g., a processor controlling or otherwise coupled to the receiver 610, the transmitter 615, the communications manager 620, or a combination thereof) may support techniques for aperiodic SRS triggering with added flexibly, resulting in increased system efficiency, efficient use of available resources, decreased system congestion, decreased system latency, and the like. Additionally, such techniques may be implemented without sacrificing size and efficiency of DCI signaling and decoding, or increasing overhead.

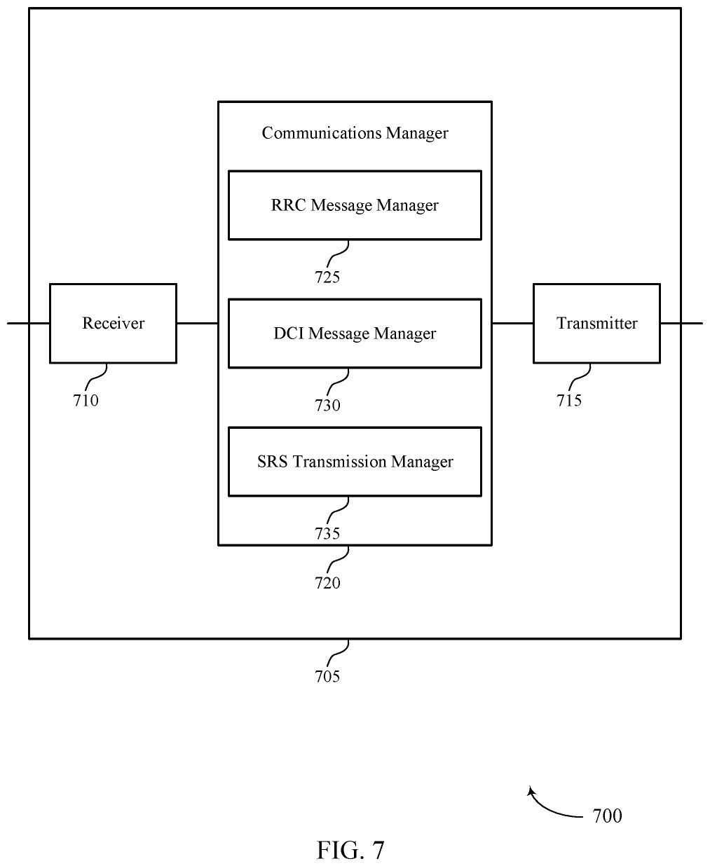

FIG. 7 shows a diagram 700 of a device 705 that supports flexible aperiodic sounding reference signal triggering in accordance with aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to flexible aperiodic sounding reference signal triggering). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to flexible aperiodic sounding reference signal triggering). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of flexible aperiodic sounding reference signal triggering as described herein. For example, the communications manager 720 may include an RRC message manager 725, a DCI message manager 730, an SRS transmission manager 735, or any combination thereof. The communications manager 720 may be an example of aspects of a communications manager 620 as described herein. In some examples, the communications manager 720, or various components thereof, may be configured to perform various operations (e.g., receiving, monitoring, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to receive information, transmit information, or perform various other operations as described herein.

The communications manager 720 may support wireless communications at a UE in accordance with examples as disclosed herein. The RRC message manager 725 may be configured as or otherwise support a means for receiving, from a base station, a radio resource control message including an indication of one or more available transmission time intervals for transmitting aperiodic sounding reference signals. The DCI message manager 730 may be configured as or otherwise support a means for receiving, from the base station, a first downlink control information message triggering a transmission of one or more aperiodic sounding reference signals on a sounding reference signal resource set. The SRS transmission manager 735 may be configured as or otherwise support a means for transmitting, to the base station during a first available transmission time interval, the one or more aperiodic sounding reference signals on the sounding reference signal resource set, where the transmitting during the first available transmission time interval is based on a first code point of the first downlink control information message and the indication of the one or more available transmission time intervals.

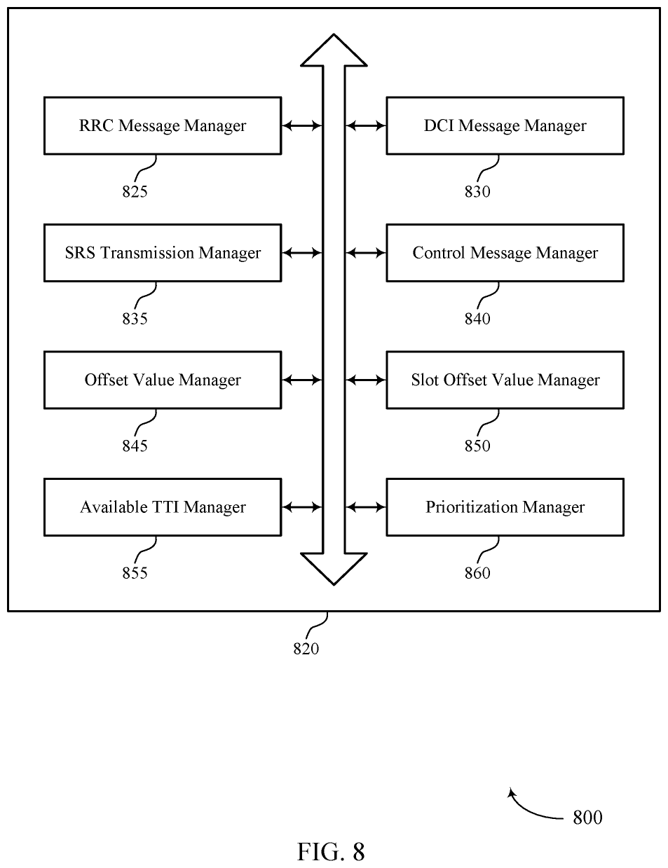

FIG. 8 shows a diagram 800 of a communications manager 820 that supports flexible aperiodic sounding reference signal triggering in accordance with aspects of the present disclosure. The communications manager 820 may be an example of aspects of a communications manager 620, a communications manager 720, or both, as described herein. The communications manager 820, or various components thereof, may be an example of means for performing various aspects of flexible aperiodic sounding reference signal triggering as described herein. For example, the communications manager 820 may include an RRC message manager 825, a DCI message manager 830, an SRS transmission manager 835, a control message manager 840, an offset value manager 845, a slot offset value manager 850, an available TTI manager 855, a prioritization manager 860, or any combination thereof. Each of these components may communicate, directly or indirectly, with one another (e.g., via one or more buses).

The communications manager 820 may support wireless communications at a UE in accordance with examples as disclosed herein. The RRC message manager 825 may be configured as or otherwise support a means for receiving, from a base station, a radio resource control message including an indication of one or more available transmission time intervals for transmitting aperiodic sounding reference signals. The DCI message manager 830 may be configured as or otherwise support a means for receiving, from the base station, a first downlink control information message triggering a transmission of one or more aperiodic sounding reference signals on a sounding reference signal resource set. The SRS transmission manager 835 may be configured as or otherwise support a means for transmitting, to the base station during a first available transmission time interval, the one or more aperiodic sounding reference signals on the sounding reference signal resource set, where the transmitting during the first available transmission time interval is based on a first code point of the first downlink control information message and the indication of the one or more available transmission time intervals.

In some examples, to support indication of the one or more available transmission time intervals, the RRC message manager 825 may be configured as or otherwise support a means for transmitting an RRC message including an indication of a set of multiple available transmission time intervals, each available transmission time interval of the multiple available transmission time intervals corresponding to a respective code point of a set of code points including the first code point of the first downlink control information message.

In some examples, to support indication of the one or more available transmission time intervals, the RRC message manager 825 may be configured as or otherwise support a means for transmitting an RRC message including an indication of a single available transmission time interval, where each offset value of a set of offset values from the single available transmission time interval correspond to respective code points of a set of code points including the first code point of the first downlink control information message.

In some examples, the offset value manager 845 may be configured as or otherwise support a means for adding a first offset value of the set of offset values to the single available transmission time interval, the first offset value corresponding to the first code point. In some examples, the offset value manager 845 may be configured as or otherwise support a means for identifying, based on the adding, the first available transmission time interval.

In some examples, to support indication of the one or more available transmission time intervals, the RRC message manager 825 may be configured as or otherwise support a means for transmitting an RRC message including an indication of the first available transmission time interval and a second available transmission time interval.

In some examples, the DCI message manager 830 may be configured as or otherwise support a means for receiving, in the first downlink control information message, an aperiodic sounding reference signal trigger including the first code point, where the first code point includes a first bit of the aperiodic sounding reference signal trigger indicating a first sounding reference signal configuration and a second bit of the aperiodic sounding reference signal trigger indicating the first available transmission time interval.

In some examples, the control message manager 840 may be configured as or otherwise support a means for receiving, from the base station, a control message including an indication of one or more updated available transmission time intervals for transmitting aperiodic sounding reference signals, one or more updated values for a set of code points including the first code point, or any combination thereof.

In some examples, the control message includes a MAC control element (CE).

In some examples, the control message manager 840 may be configured as or otherwise support a means for transmitting a MAC-CE message including an instruction to add or remove one or more entries in a table indicating the available transmission time intervals, or an instruction to enable or disable one or more entries in a table indicating the available transmission time intervals, or both.

In some examples, to support indication of one or more updated values for the set of code points, the control message manager 840 may be configured as or otherwise support a means for transmitting a MAC-CE message including an instruction to add or remove one or more code points of the set of code points, or an instruction to enable or disable one or more code points of the set of code points, or both.

In some examples, the MAC-CE includes an instruction to modify a mapping between the set of code points and the available transmission time intervals.

In some examples, the RRC message manager 825 may be configured as or otherwise support a means for receiving, from the base station, a second radio resource control message including a slot offset value indicating a second available transmission time interval for transmitting aperiodic sounding reference signals. In some examples, the DCI message manager 830 may be configured as or otherwise support a means for receiving, from the base station, a second downlink control information message triggering a transmission of one or more aperiodic sounding reference signals on a second sounding reference signal resource set. In some examples, the SRS transmission manager 835 may be configured as or otherwise support a means for transmitting, to the base station during the second available transmission time interval, the one or more aperiodic sounding reference signals on the second sounding reference signal resource set, where the transmitting during the second available transmission time interval is based on determining that one or more sounding reference signal configuration conditions are satisfied.

In some examples, the RRC message manager 825 may be configured as or otherwise support a means for determining that the second radio resource control message does not include the indication of the one or more available transmission time intervals for transmitting aperiodic sounding reference signals, where transmitting the one or more aperiodic sounding reference signals during the second available transmission time interval is based on the determining.

In some examples, the slot offset value manager 850 may be configured as or otherwise support a means for receiving, in the second radio resource control message, an instruction to use the slot offset value indicating the second available transmission time interval, where transmitting the one or more aperiodic sounding reference signals during the second available transmission time interval is based on receiving the instruction.

In some examples, the SRS transmission manager 835 may be configured as or otherwise support a means for identifying a format of the second downlink control information message, a core resource set associated with the second downlink control information message, a synchronization signal associated with the second downlink control information message, or any combination thereof, where transmitting the one or more aperiodic sounding reference signals during the second available transmission time interval is based on the identifying.

In some examples, the RRC message manager 825 may be configured as or otherwise support a means for receiving, from the base station, a second radio resource control message including a second indication of one or more available transmission time intervals for transmitting aperiodic sounding reference signals. In some examples, the DCI message manager 830 may be configured as or otherwise support a means for receiving, from the base station, a second downlink control information message triggering a transmission of one or more aperiodic sounding reference signals on a second sounding reference signal resource set, where the first downlink control information message is a scheduling downlink control information message and the second downlink control information message is a non-scheduling downlink control information message including an indication of a second available transmission time interval. In some examples, the SRS transmission manager 835 may be configured as or otherwise support a means for transmitting, to the base station during the second available transmission time interval, the one or more aperiodic sounding reference signals on the second sounding reference signal resource set, where the transmitting during the second available transmission time interval is based on the indication of the second available transmission time interval.

In some examples, the available TTI manager 855 may be configured as or otherwise support a means for identifying a third available transmission time interval based on a second code point of the second downlink control information message and the second indication of the one or more available transmission time intervals. In some examples, the prioritization manager 860 may be configured as or otherwise support a means for prioritizing the second available transmission time interval based on the second downlink control information message being a non-scheduling downlink control information message.

In some examples, the DCI message manager 830 may be configured as or otherwise support a means for receiving, in the second downlink control information message, an aperiodic sounding reference signal trigger including a second code point, where the second code point includes a first bit of the aperiodic sounding reference signal trigger indicating the second available transmission time interval for non-scheduling downlink control information messages and a second bit of the aperiodic sounding reference signal trigger indicating a third available transmission time interval for scheduling downlink control information messages. In some examples, the prioritization manager 860 may be configured as or otherwise support a means for prioritizing the second available transmission time interval based on receiving the second downlink control information message.

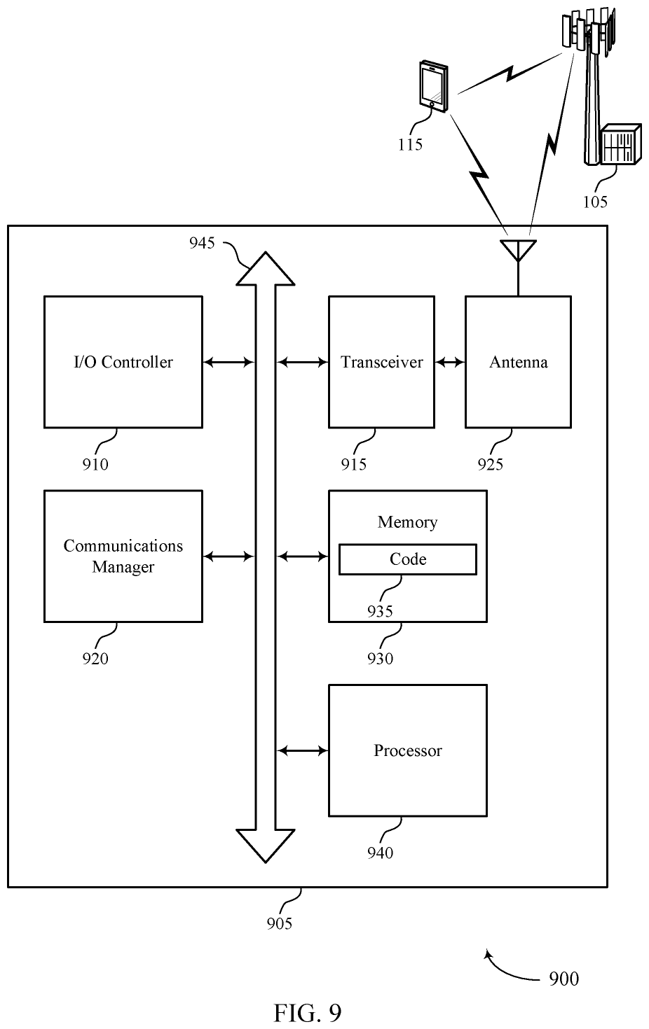

FIG. 9 shows a diagram of a system 900 including a device 905 that supports flexible aperiodic sounding reference signal triggering in accordance with aspects of the present disclosure. The device 905 may be an example of or include the components of a device 605, a device 705, or a UE 115 as described herein. The device 905 may communicate wirelessly with one or more base stations 105, UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting flexible aperiodic sounding reference signal triggering). For example, the device 905 or a component of the device 905 may include a processor 940 and memory 930 coupled to the processor 940, the processor 940 and memory 930 configured to perform various functions described herein.

The communications manager 920 may support wireless communications at a UE in accordance with examples as disclosed herein. For example, the communications manager 920 may be configured as or otherwise support a means for receiving, from a base station, a radio resource control message including an indication of one or more available transmission time intervals for transmitting aperiodic sounding reference signals. The communications manager 920 may be configured as or otherwise support a means for receiving, from the base station, a first downlink control information message triggering a transmission of one or more aperiodic sounding reference signals on a sounding reference signal resource set. The communications manager 920 may be configured as or otherwise support a means for transmitting, to the base station during a first available transmission time interval, the one or more aperiodic sounding reference signals on the sounding reference signal resource set, where the transmitting during the first available transmission time interval is based on a first code point of the first downlink control information message and the indication of the one or more available transmission time intervals.

By including or configuring the communications manager 920 in accordance with examples as described herein, the device 905 may support techniques for aperiodic SRS triggering with added flexibly, resulting in increased system efficiency, efficient use of available resources, decreased system congestion, decreased system latency, and the like. Additionally, such techniques may be implemented without sacrificing size and efficiency of DCI signaling and decoding, or increasing overhead.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of flexible aperiodic sounding reference signal triggering as described herein, or the processor 940 and the memory 930 may be otherwise configured to perform or support such operations.

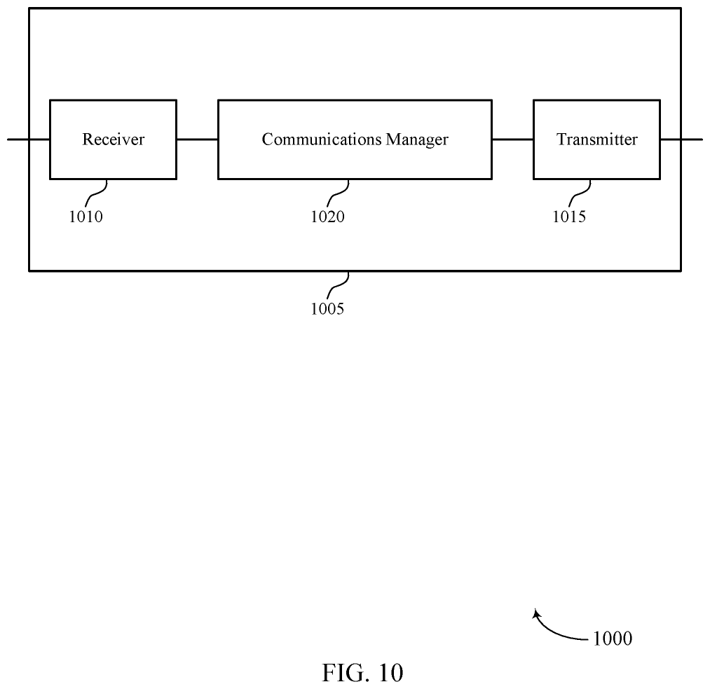

FIG. 10 shows a diagram 1000 of a device 1005 that supports flexible aperiodic sounding reference signal triggering in accordance with aspects of the present disclosure. The device 1005 may be an example of aspects of a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to flexible aperiodic sounding reference signal triggering). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to flexible aperiodic sounding reference signal triggering). In some examples, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of flexible aperiodic sounding reference signal triggering as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 1020 may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. For example, the communications manager 1020 may be configured as or otherwise support a means for transmitting, to a UE, a radio resource control message including an indication of one or more available transmission time intervals for transmitting aperiodic sounding reference signals. The communications manager 1020 may be configured as or otherwise support a means for transmitting, to the UE, a first downlink control information message triggering a transmission of one or more aperiodic sounding reference signals on a sounding reference signal resource set. The communications manager 1020 may be configured as or otherwise support a means for receiving, from the UE during a first available transmission time interval, the one or more aperiodic sounding reference signals on the sounding reference signal resource set, where the receiving during the first available transmission time interval is based on a first code point of the first downlink control information message and the indication of the one or more available transmission time intervals.

By including or configuring the communications manager 1020 in accordance with examples as described herein, the device 1005 (e.g., a processor controlling or otherwise coupled to the receiver 1010, the transmitter 1015, the communications manager 1020, or a combination thereof) may support techniques for aperiodic SRS triggering with added flexibly, resulting in increased system efficiency, efficient use of available resources, decreased system congestion, decreased system latency, and the like. Additionally, such techniques may be implemented without sacrificing size and efficiency of DCI signaling and decoding, or increasing overhead.

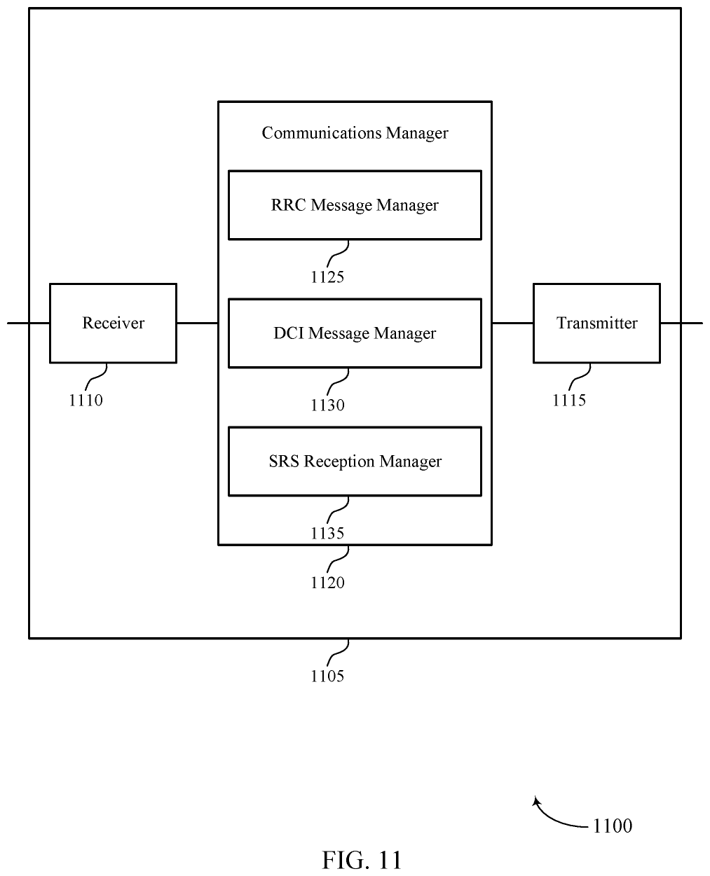

FIG. 11 shows a diagram 1100 of a device 1105 that supports flexible aperiodic sounding reference signal triggering in accordance with aspects of the present disclosure. The device 1105 may be an example of aspects of a device 1005 or a base station 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to flexible aperiodic sounding reference signal triggering). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to flexible aperiodic sounding reference signal triggering). In some examples, the transmitter 1115 may be co-located with a receiver 1110 in a transceiver module. The transmitter 1115 may utilize a single antenna or a set of multiple antennas.

The device 1105, or various components thereof, may be an example of means for performing various aspects of flexible aperiodic sounding reference signal triggering as described herein. For example, the communications manager 1120 may include an RRC message manager 1125, a DCI message manager 1130, an SRS reception manager 1135, or any combination thereof. The communications manager 1120 may be an example of aspects of a communications manager 1020 as described herein. In some examples, the communications manager 1120, or various components thereof, may be configured to perform various operations (e.g., receiving, monitoring, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to receive information, transmit information, or perform various other operations as described herein.

The communications manager 1120 may support wireless communications at a base station in accordance with examples as disclosed herein. The RRC message manager 1125 may be configured as or otherwise support a means for transmitting, to a UE, a radio resource control message including an indication of one or more available transmission time intervals for transmitting aperiodic sounding reference signals. The DCI message manager 1130 may be configured as or otherwise support a means for transmitting, to the UE, a first downlink control information message triggering a transmission of one or more aperiodic sounding reference signals on a sounding reference signal resource set. The SRS reception manager 1135 may be configured as or otherwise support a means for receiving, from the UE during a first available transmission time interval, the one or more aperiodic sounding reference signals on the sounding reference signal resource set, where the receiving during the first available transmission time interval is based on a first code point of the first downlink control information message and the indication of the one or more available transmission time intervals.

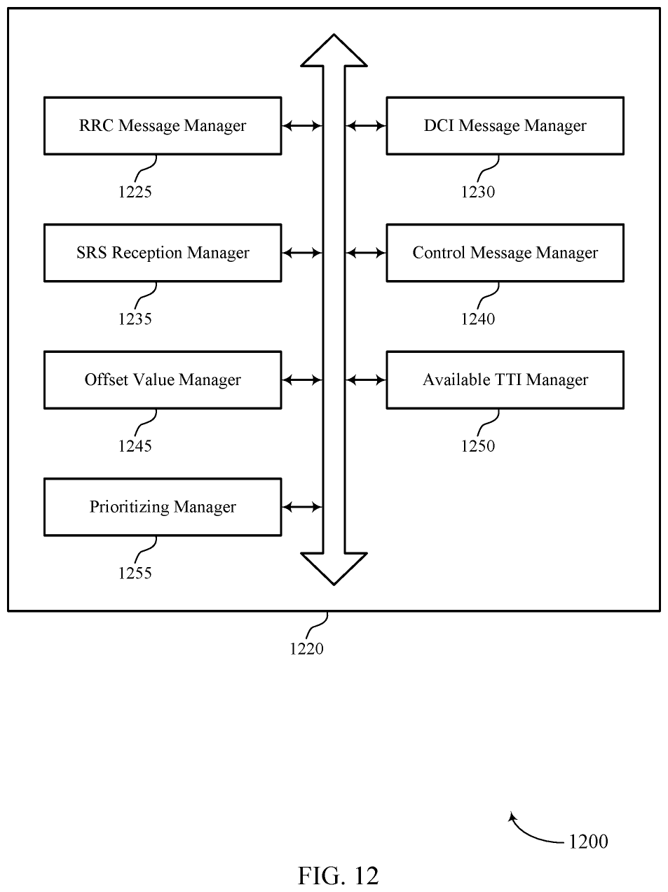

FIG. 12 shows a diagram 1200 of a communications manager 1220 that supports flexible aperiodic sounding reference signal triggering in accordance with aspects of the present disclosure. The communications manager 1220 may be an example of aspects of a communications manager 1020, a communications manager 1120, or both, as described herein. The communications manager 1220, or various components thereof, may be an example of means for performing various aspects of flexible aperiodic sounding reference signal triggering as described herein. For example, the communications manager 1220 may include an RRC message manager 1225, a DCI message manager 1230, an SRS reception manager 1235, a control message manager 1240, an offset value manager 1245, an available TTI manager 1250, a prioritizing manager 1255, or any combination thereof. Each of these components may communicate, directly or indirectly, with one another (e.g., via one or more buses).

The communications manager 1220 may support wireless communications at a base station in accordance with examples as disclosed herein. The RRC message manager 1225 may be configured as or otherwise support a means for transmitting, to a UE, a radio resource control message including an indication of one or more available transmission time intervals for transmitting aperiodic sounding reference signals. The DCI message manager 1230 may be configured as or otherwise support a means for transmitting, to the UE, a first downlink control information message triggering a transmission of one or more aperiodic sounding reference signals on a sounding reference signal resource set. The SRS reception manager 1235 may be configured as or otherwise support a means for receiving, from the UE during a first available transmission time interval, the one or more aperiodic sounding reference signals on the sounding reference signal resource set, where the receiving during the first available transmission time interval is based on a first code point of the first downlink control information message and the indication of the one or more available transmission time intervals.

In some examples, to support indication of the one or more available transmission time intervals, the RRC message manager 1225 may be configured as or otherwise support a means for transmitting an RRC message including an indication of a set of multiple available transmission time intervals, each available transmission time interval of the set of multiple available transmission time intervals corresponding to a respective code point of a set of code points including the first code point of the first downlink control information message.

In some examples, to support indication of the one or more available transmission time intervals, the RRC message manager 1225 may be configured as or otherwise support a means for transmitting an RRC message including an indication of a single available transmission time interval, where each offset value of a set of offset values from the single available transmission time interval corresponds to respective code points of a set of code points including the first code point of the first downlink control information message.

In some examples, the offset value manager 1245 may be configured as or otherwise support a means for adding a first offset value of the set of offset values to the single available transmission time interval, the first offset value corresponding to the first code point. In some examples, the available TTI manager 1250 may be configured as or otherwise support a means for identifying, based on the adding, the first available transmission time interval.

In some examples, to support indication of the one or more available transmission time intervals, the RRC message manager 1225 may be configured as or otherwise support a means for transmitting an RRC message including an indication of the first available transmission time interval and a second available transmission time interval.

In some examples, the DCI message manager 1230 may be configured as or otherwise support a means for transmitting, in the first downlink control information message, an aperiodic sounding reference signal trigger including the first code point, where the first code point includes a first bit of the aperiodic sounding reference signal trigger indicating a first sounding reference signal configuration and a second bit of the aperiodic sounding reference signal trigger indicating the first available transmission time interval.

In some examples, the control message manager 1240 may be configured as or otherwise support a means for transmitting, to the UE, a control message including an indication of one or more updated available transmission time intervals for transmitting aperiodic sounding reference signals, one or more updated values for a set of code points including the first code point, or any combination thereof.

In some examples, the control message includes a MAC control element (CE).

In some examples, to support indication of one or more updated available transmission time intervals or transmitting aperiodic sounding reference signals, the control message manager 1240 may be configured as or otherwise support a means for transmitting a control message including an instruction to add or remove one or more entries in a table indicating the available transmission time intervals, or an instruction to enable or disable one or more entries in a table indicating the available transmission time intervals, or both.

In some examples, to support indication of one or more updated values for the set of code points, the control message manager 1240 may be configured as or otherwise support a means for transmitting a control message including an instruction to add or remove one or more code points of the set of code points, or an instruction to enable or disable one or more code points of the set of code points, or both.

In some examples, the MAC-CE includes an instruction to modify a mapping between the set of code points and the available transmission time intervals.

In some examples, the RRC message manager 1225 may be configured as or otherwise support a means for transmitting, to the UE, a second radio resource control message including a slot offset value indicating a second available transmission time interval for transmitting aperiodic sounding reference signals. In some examples, the DCI message manager 1230 may be configured as or otherwise support a means for transmitting, to the UE, a second downlink control information message triggering a transmission of one or more aperiodic sounding reference signals on a second sounding reference signal resource set. In some examples, the SRS reception manager 1235 may be configured as or otherwise support a means for receiving, from the UE during the second available transmission time interval, the one or more aperiodic sounding reference signals on the second sounding reference signal resource set, where the receiving during the second available transmission time interval is based on determining that one or more sounding reference signal configuration conditions are satisfied.

In some examples, the RRC message manager 1225 may be configured as or otherwise support a means for determining that the second radio resource control message does not include the indication of the one or more available transmission time intervals for transmitting aperiodic sounding reference signals, where receiving the one or more aperiodic sounding reference signals during the second available transmission time interval is based on the determining.

In some examples, the RRC message manager 1225 may be configured as or otherwise support a means for transmitting, in the second radio resource control message, an instruction to use the slot offset value indicating the second available transmission time interval, where receiving the one or more aperiodic sounding reference signals during the second available transmission time interval is based on transmitting the instruction.

In some examples, the SRS reception manager 1235 may be configured as or otherwise support a means for identifying a format of the second downlink control information message, a core resource set associated with the second downlink control information message, a synchronization signal associated with the second downlink control information message, or any combination thereof, where receiving the one or more aperiodic sounding reference signals during the second available transmission time interval is based on the identifying.

In some examples, the RRC message manager 1225 may be configured as or otherwise support a means for transmitting, to the base station, a second radio resource control message including a second indication of one or more available transmission time intervals for transmitting aperiodic sounding reference signals. In some examples, the DCI message manager 1230 may be configured as or otherwise support a means for transmitting, to the UE, a second downlink control information message triggering a transmission of one or more aperiodic sounding reference signals on a second sounding reference signal resource set, where the first downlink control information message is a scheduling downlink control information message and the second downlink control information message is a non-scheduling downlink control information message including an indication of a second available transmission time interval. In some examples, the SRS reception manager 1235 may be configured as or otherwise support a means for receiving, from the UE during the second available transmission time interval, the one or more aperiodic sounding reference signals on the second sounding reference signal resource set, where the receiving during the second available transmission time interval is based on the indication of the second available transmission time interval.

In some examples, the available TTI manager 1250 may be configured as or otherwise support a means for identifying a third available transmission time interval based on a second code point of the second downlink control information message and the second indication of the one or more available transmission time intervals. In some examples, the prioritizing manager 1255 may be configured as or otherwise support a means for prioritizing the second available transmission time interval based on the second downlink control information message being a non-scheduling downlink control information message.

In some examples, the DCI message manager 1230 may be configured as or otherwise support a means for transmitting, in the second downlink control information message, an aperiodic sounding reference signal trigger including a second code point, where the second code point includes a first bit of the aperiodic sounding reference signal trigger indicating the second available transmission time interval for non-scheduling downlink control information messages and a second bit of the aperiodic sounding reference signal trigger indicating a third available transmission time interval for scheduling downlink control information messages. In some examples, the prioritizing manager 1255 may be configured as or otherwise support a means for prioritizing the second available transmission time interval based on receiving the second downlink control information message.

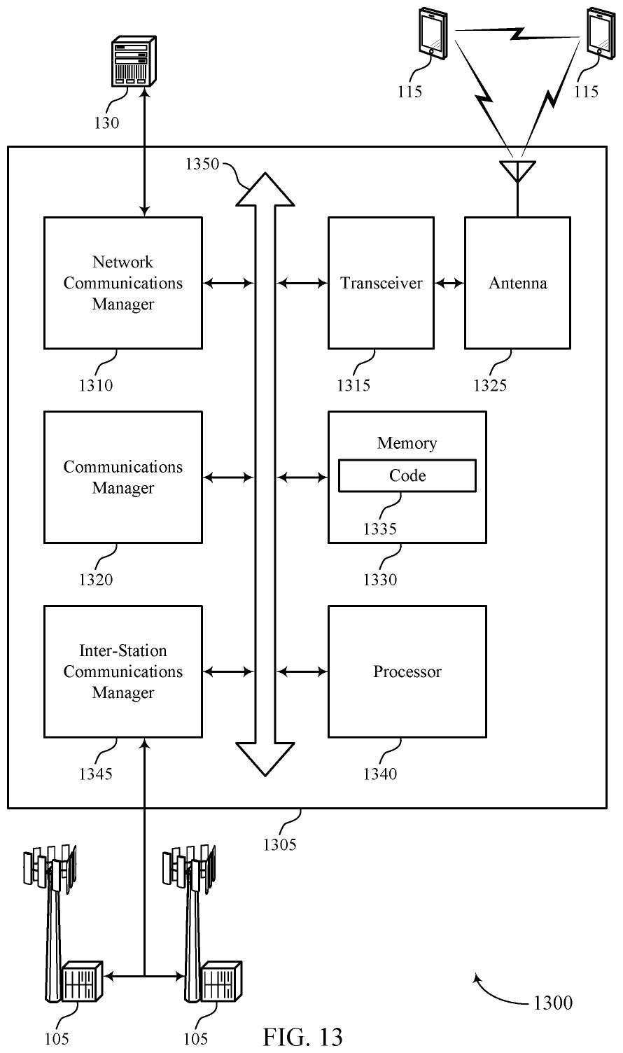

FIG. 13 shows a diagram of a system 1300 including a device 1305 that supports flexible aperiodic sounding reference signal triggering in accordance with aspects of the present disclosure. The device 1305 may be an example of or include the components of a device 1005, a device 1105, or a base station 105 as described herein. The device 1305 may communicate wirelessly with one or more base stations 105, UEs 115, or any combination thereof. The device 1305 may include components for bi-directional voice and data communications including components for transmitting and receiving communications, such as a communications manager 1320, a network communications manager 1310, a transceiver 1315, an antenna 1325, a memory 1330, code 1335, a processor 1340, and an inter-station communications manager 1345. These components may be in electronic communication or otherwise coupled (e.g., operatively, communicatively, functionally, electronically, electrically) via one or more buses (e.g., a bus 1350).

The network communications manager 1310 may manage communications with a core network 130 (e.g., via one or more wired backhaul links). For example, the network communications manager 1310 may manage the transfer of data communications for client devices, such as one or more UEs 115.

In some cases, the device 1305 may include a single antenna 1325. However, in some other cases the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting flexible aperiodic sounding reference signal triggering). For example, the device 1305 or a component of the device 1305 may include a processor 1340 and memory 1330 coupled to the processor 1340, the processor 1340 and memory 1330 configured to perform various functions described herein.

The inter-station communications manager 1345 may manage communications with other base stations 105, and may include a controller or scheduler for controlling communications with UEs 115 in cooperation with other base stations 105. For example, the inter-station communications manager 1345 may coordinate scheduling for transmissions to UEs 115 for various interference mitigation techniques such as beamforming or joint transmission. In some examples, the inter-station communications manager 1345 may provide an X2 interface within an LTE/LTE-A wireless communications network technology to provide communication between base stations 105.

The communications manager 1320 may support wireless communications at a base station in accordance with examples as disclosed herein. For example, the communications manager 1320 may be configured as or otherwise support a means for transmitting, to a UE, a radio resource control message including an indication of one or more available transmission time intervals for transmitting aperiodic sounding reference signals. The communications manager 1320 may be configured as or otherwise support a means for transmitting, to the UE, a first downlink control information message triggering a transmission of one or more aperiodic sounding reference signals on a sounding reference signal resource set. The communications manager 1320 may be configured as or otherwise support a means for receiving, from the UE during a first available transmission time interval, the one or more aperiodic sounding reference signals on the sounding reference signal resource set, where the receiving during the first available transmission time interval is based on a first code point of the first downlink control information message and the indication of the one or more available transmission time intervals.

By including or configuring the communications manager 1320 in accordance with examples as described herein, the device 1305 may support techniques for aperiodic SRS triggering with added flexibly, resulting in increased system efficiency, efficient use of available resources, decreased system congestion, decreased system latency, and the like. Additionally, such techniques may be implemented without sacrificing size and efficiency of DCI signaling and decoding, or increasing overhead.

In some examples, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some examples, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of flexible aperiodic sounding reference signal triggering as described herein, or the processor 1340 and the memory 1330 may be otherwise configured to perform or support such operations.

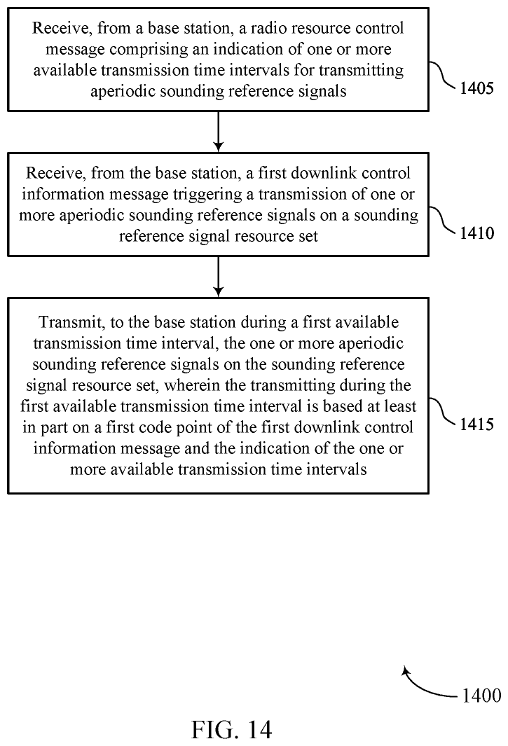

FIG. 14 shows a flowchart illustrating a method 1400 that supports flexible aperiodic sounding reference signal triggering in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving, from a base station, a radio resource control message including an indication of one or more available transmission time intervals for transmitting aperiodic sounding reference signals. The operations of 1405 may be performed in accordance with examples as disclosed herein. In some examples, aspects of the operations of 1405 may be performed by an RRC message manager 825 as described with reference to FIG. 8.

At 1410, the method may include receiving, from the base station, a first downlink control information message triggering a transmission of one or more aperiodic sounding reference signals on a sounding reference signal resource set. The operations of 1410 may be performed in accordance with examples as disclosed herein. In some examples, aspects of the operations of 1410 may be performed by a DCI message manager 830 as described with reference to FIG. 8.

At 1415, the method may include transmitting, to the base station during a first available transmission time interval, the one or more aperiodic sounding reference signals on the sounding reference signal resource set, where the transmitting during the first available transmission time interval is based on a first code point of the first downlink control information message and the indication of the one or more available transmission time intervals. The operations of 1415 may be performed in accordance with examples as disclosed herein. In some examples, aspects of the operations of 1415 may be performed by an SRS transmission manager 835 as described with reference to FIG. 8.

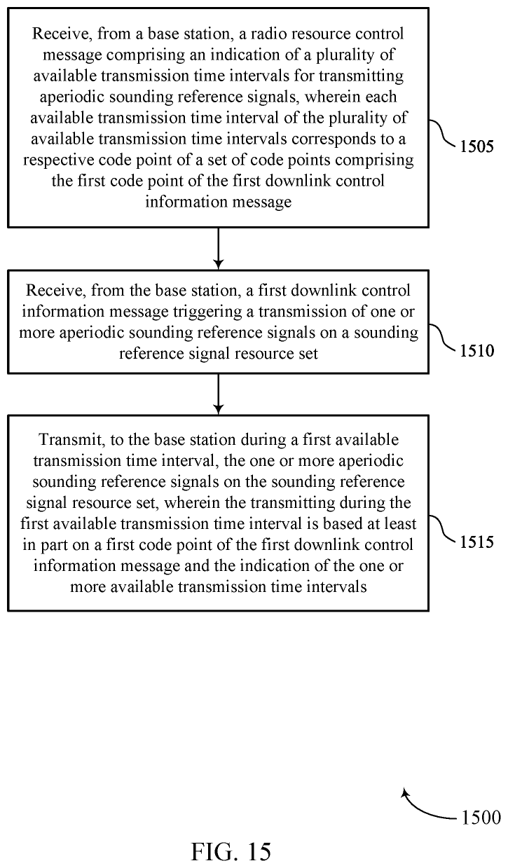

FIG. 15 shows a flowchart illustrating a method 1500 that supports flexible aperiodic sounding reference signal triggering in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving, from a base station, a radio resource control message including an indication of one or more available transmission time intervals for transmitting aperiodic sounding reference signals a radio resource control message comprising an indication of a plurality of available transmission time intervals for transmitting aperiodic sounding reference signals, wherein each available transmission time interval of the plurality of available transmission time intervals corresponds to a respective code point of a set of code points comprising the first code point of the first downlink control information message. The operations of 1505 may be performed in accordance with examples as disclosed herein. In some examples, aspects of the operations of 1505 may be performed by an RRC message manager 825 as described with reference to FIG. 8.

At 1510, the method may include receiving, from the base station, a first downlink control information message triggering a transmission of one or more aperiodic sounding reference signals on a sounding reference signal resource set. The operations of 1510 may be performed in accordance with examples as disclosed herein. In some examples, aspects of the operations of 1510 may be performed by a DCI message manager 830 as described with reference to FIG. 8.

At 1515, the method may include transmitting, to the base station during a first available transmission time interval, the one or more aperiodic sounding reference signals on the sounding reference signal resource set, wherein the transmitting during the first available transmission time interval is based at least in part on a first code point of the first downlink control information message and the indication of the one or more available transmission time intervals. The operations of 1515 may be performed in accordance with examples as disclosed herein. In some examples, aspects of the operations of 1515 may be performed by an SRS transmission manager 835 as described with reference to FIG. 8.

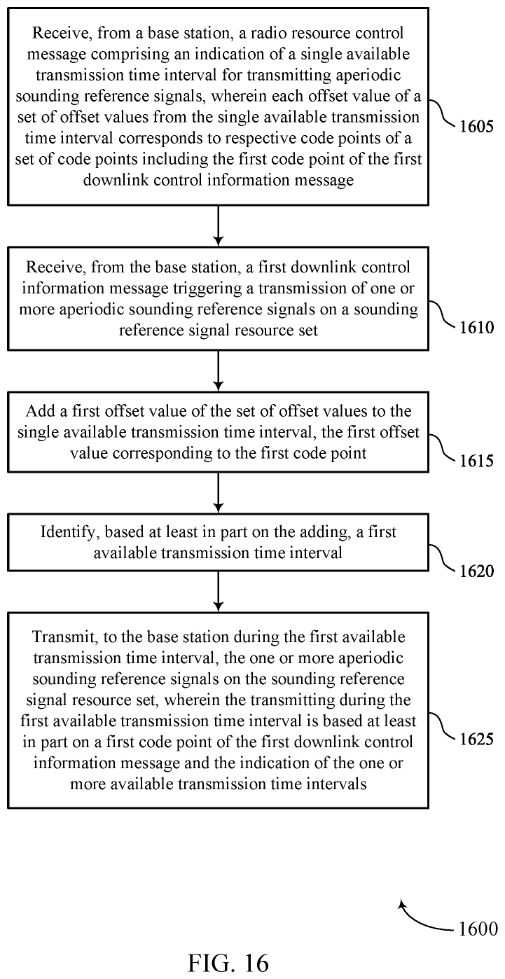

FIG. 16 shows a flowchart illustrating a method 1600 that supports flexible aperiodic sounding reference signal triggering in accordance with aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving, from a base station, a radio resource control message comprising an indication of a single available transmission time interval for transmitting aperiodic sounding reference signals, wherein each offset value of a set of offset values from the single available transmission time interval corresponds to respective code points of a set of code points including the first code point of the first downlink control information message. The operations of 1605 may be performed in accordance with examples as disclosed herein. In some examples, aspects of the operations of 1605 may be performed by an RRC message manager 825 as described with reference to FIG. 8.

At 1610, the method may include receiving, from the base station, a first downlink control information message triggering a transmission of one or more aperiodic sounding reference signals on a sounding reference signal resource set. The operations of 1610 may be performed in accordance with examples as disclosed herein. In some examples, aspects of the operations of 1610 may be performed by a DCI message manager 830 as described with reference to FIG. 8.

At 1615, the method may include adding from the base station, a first downlink control information message triggering a transmission of one or more aperiodic sounding reference signals on a sounding reference signal resource set. The operations of 1615 may be performed in accordance with examples as disclosed herein. In some examples, aspects of the operations of 1615 may be performed by an offset value manager 845 as described with reference to FIG. 8.

At 1620, the method may include identifying, from the base station, a first downlink control information message triggering a transmission of one or more aperiodic sounding reference signals on a sounding reference signal resource set. The operations of 1620 may be performed in accordance with examples as disclosed herein. In some examples, aspects of the operations of 1620 may be performed by an offset value manager 845 as described with reference to FIG. 8.

At 1625, the method may include transmitting, to the base station during the first available transmission time interval, the one or more aperiodic sounding reference signals on the sounding reference signal resource set, wherein the transmitting during the first available transmission time interval is based at least in part on a first code point of the first downlink control information message and the indication of the one or more available transmission time intervals. The operations of 1625 may be performed in accordance with examples as disclosed herein. In some examples, aspects of the operations of 1625 may be performed by an SRS transmission manager 835 as described with reference to FIG. 8.

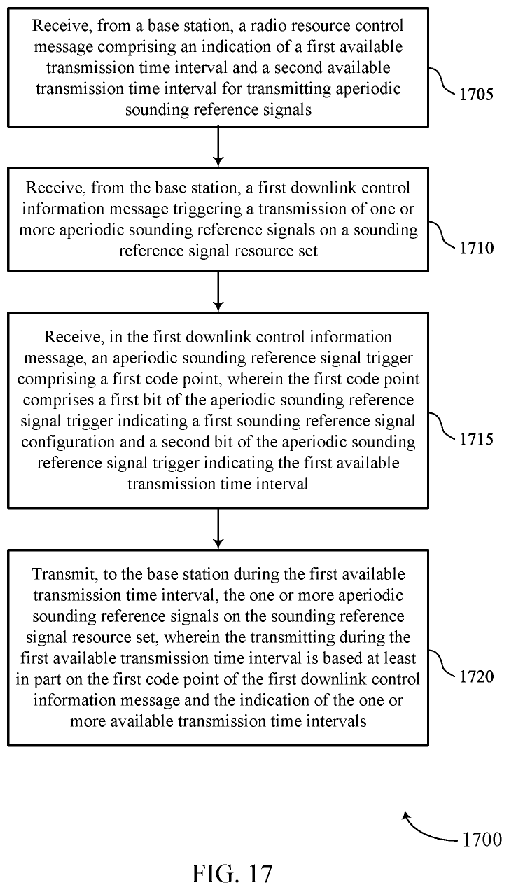

FIG. 17 shows a flowchart illustrating a method 1700 that supports flexible aperiodic sounding reference signal triggering in accordance with aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving, from a base station, a radio resource control message comprising an indication of a first available transmission time interval and a second available transmission time interval for transmitting aperiodic sounding reference signals. The operations of 1705 may be performed in accordance with examples as disclosed herein. In some examples, aspects of the operations of 1705 may be performed by an RRC message manager 825 as described with reference to FIG. 8.

At 1710, the method may include receiving, from the base station, a first downlink control information message triggering a transmission of one or more aperiodic sounding reference signals on a sounding reference signal resource set. The operations of 1710 may be performed in accordance with examples as disclosed herein. In some examples, aspects of the operations of 1710 may be performed by a DCI message manager 830 as described with reference to FIG. 8.

At 1715, the method may include receiving, in the first downlink control information message, an aperiodic sounding reference signal trigger comprising a first code point, wherein the first code point comprises a first bit of the aperiodic sounding reference signal trigger indicating a first sounding reference signal configuration and a second bit of the aperiodic sounding reference signal trigger indicating the first available transmission time interval. The operations of 1715 may be performed in accordance with examples as disclosed herein. In some examples, aspects of the operations of 1715 may be performed by a DCI message manager 830 as described with reference to FIG. 8.

At 1720, the method may include transmitting, to the base station during the first available transmission time interval, the one or more aperiodic sounding reference signals on the sounding reference signal resource set, wherein the transmitting during the first available transmission time interval is based at least in part on the first code point of the first downlink control information message and the indication of the one or more available transmission time intervals. The operations of 1720 may be performed in accordance with examples as disclosed herein. In some examples, aspects of the operations of 1720 may be performed by an SRS transmission manager 835 as described with reference to FIG. 8.

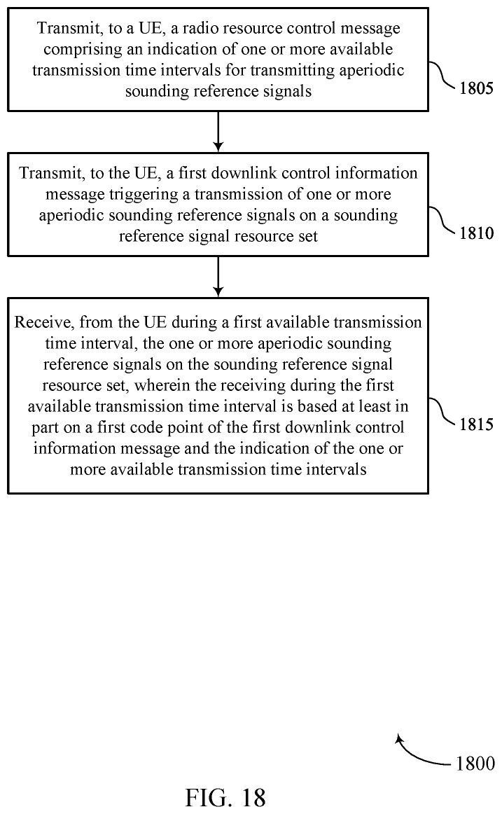

FIG. 18 shows a flowchart illustrating a method 1800 that supports flexible aperiodic sounding reference signal triggering in accordance with aspects of the present disclosure. The operations of the method 1800 may be implemented by a base station or its components as described herein. For example, the operations of the method 1800 may be performed by a base station 105 as described with reference to FIGS. 1 through 5 and 10 through 13. In some examples, a base station may execute a set of instructions to control the functional elements of the base station to perform the described functions. Additionally, or alternatively, the base station may perform aspects of the described functions using special-purpose hardware.

At 1805, the method may include transmitting, to a UE, a radio resource control message including an indication of one or more available transmission time intervals for transmitting aperiodic sounding reference signals. The operations of 1805 may be performed in accordance with examples as disclosed herein. In some examples, aspects of the operations of 1805 may be performed by an RRC message manager 1225 as described with reference to FIG. 12.

At 1810, the method may include transmitting, to the UE, a first downlink control information message triggering a transmission of one or more aperiodic sounding reference signals on a sounding reference signal resource set. The operations of 1810 may be performed in accordance with examples as disclosed herein. In some examples, aspects of the operations of 1810 may be performed by a DCI message manager 1230 as described with reference to FIG. 12.

At 1815, the method may include receiving, from the UE during a first available transmission time interval, the one or more aperiodic sounding reference signals on the sounding reference signal resource set, where the receiving during the first available transmission time interval is based on a first code point of the first downlink control information message and the indication of the one or more available transmission time intervals. The operations of 1815 may be performed in accordance with examples as disclosed herein. In some examples, aspects of the operations of 1815 may be performed by an SRS reception manager 1235 as described with reference to FIG. 12.

The following provides an overview of aspects of the present disclosure:

Aspect 1: A method for wireless communications at a UE, comprising: receiving, from a base station, a radio resource control message comprising an indication of one or more available transmission time intervals for transmitting aperiodic sounding reference signals; receiving, from the base station, a first downlink control information message triggering a transmission of one or more aperiodic sounding reference signals on a sounding reference signal resource set; and transmitting, to the base station during a first available transmission time interval, the one or more aperiodic sounding reference signals on the sounding reference signal resource set, wherein the transmitting during the first available transmission time interval is based at least in part on a first code point of the first downlink control information message and the indication of the one or more available transmission time intervals.

Aspect 2: The method of aspect 1, wherein the indication of the one or more available transmission time intervals comprises: an indication of a plurality of available transmission time intervals, each available transmission time interval of a set of available transmission time intervals corresponding to a respective code point of a set of codepoints comprising the first code point of the first downlink control information message.

Aspect 3: The method of any of aspects 1 through 2, wherein the indication of the one or more available transmission time intervals comprises: an indication of a single available transmission time interval, wherein a set of offset values from the single available transmission time interval correspond to respective code points of a set of codepoints comprising the first code point of the first downlink control information message.

Aspect 4: The method of aspect 3, further comprising: adding a first offset value of the set of offset values to the single available transmission time interval, the first offset value corresponding to the first code point; and identifying, based at least in part on the adding, the first available transmission time interval.

Aspect 5: The method of any of aspects 1 through 4, wherein the indication of the one or more available transmission time intervals comprises: an indication of the first available transmission time interval and a second available transmission time interval.

Aspect 6: The method of aspect 5, further comprising: receiving, in the first downlink control information message, an aperiodic sounding reference signal trigger comprising the first code point, wherein the first code point comprises a first bit of the aperiodic sounding reference signal trigger indicating a first sounding reference signal configuration and a second bit of the aperiodic sounding reference signal trigger indicating the first available transmission time interval.

Aspect 7: The method of any of aspects 1 through 6, further comprising: receiving, from the base station, a control message comprising an indication of one or more updated available transmission time intervals for transmitting aperiodic sounding reference signals, one or more updated values for a set of code points comprising the first code point, or any combination thereof.

Aspect 8: The method of aspect 7, wherein the control message comprises a MAC control element (CE).

Aspect 9: The method of aspect 8, wherein the indication of one or more updated available transmission time intervals or transmitting aperiodic sounding reference signals comprises: an instruction to add or remove one or more entries in a table indicating the available transmission time intervals, or an instruction to enable or disable one or more entries in a table indicating the available transmission time intervals, or both.

Aspect 10: The method of any of aspects 8 through 9, wherein the indication of one or more updated values for the set of code points comprises: an instruction to add or remove one or more code points of the set of code points, or an instruction to enable or disable one or more code points of the set of code points, or both.

Aspect 11: The method of any of aspects 8 through 10, wherein the MAC-CE comprises an instruction to modify a mapping between the set of code points and the available transmission time intervals.

Aspect 12: The method of any of aspects 1 through 11, further comprising: receiving, from the base station, a second radio resource control message comprising a slot offset value indicating a second available transmission time interval for transmitting aperiodic sounding reference signals; receiving, from the base station, a second downlink control information message triggering a transmission of one or more aperiodic sounding reference signals on a second sounding reference signal resource set; and transmitting, to the base station during the second available transmission time interval, the one or more aperiodic sounding reference signals on the second sounding reference signal resource set, wherein the transmitting during the second available transmission time interval is based at least in part on determining that one or more sounding reference signal configuration conditions are satisfied.

Aspect 13: The method of aspect 12, further comprising: determining that the second radio resource control message does not include the indication of the one or more available transmission time intervals for transmitting aperiodic sounding reference signals, wherein transmitting the one or more aperiodic sounding reference signals during the second available transmission time interval is based at least in part on the determining.

Aspect 14: The method of any of aspects 12 through 13, further comprising: receiving, in the second radio resource control message, an instruction to use the slot offset value indicating the second available transmission time interval, wherein transmitting the one or more aperiodic sounding reference signals during the second available transmission time interval is based at least in part on receiving the instruction.

Aspect 15: The method of any of aspects 12 through 14, further comprising: identifying a format of the second downlink control information message, a core resource set associated with the second downlink control information message, a synchronization signal associated with the second downlink control information message, or any combination thereof, wherein transmitting the one or more aperiodic sounding reference signals during the second available transmission time interval is based at least in part on the identifying.

Aspect 16: The method of any of aspects 1 through 15, further comprising: receiving, from the base station, a second radio resource control message comprising a second indication of one or more available transmission time intervals for transmitting aperiodic sounding reference signals; receiving, from the base station, a second downlink control information message triggering a transmission of one or more aperiodic sounding reference signals on a second sounding reference signal resource set, wherein the first downlink control information message is a scheduling downlink control information message and the second downlink control information message is a non-scheduling downlink control information message comprising an indication of a second available transmission time interval; and transmitting, to the base station during the second available transmission time interval, the one or more aperiodic sounding reference signals on the second sounding reference signal resource set, wherein the transmitting during the second available transmission time interval is based at least in part on the indication of the second available transmission time interval.

Aspect 17: The method of aspect 16, further comprising: identifying a third available transmission time interval based at least in part on a second code point of the second downlink control information message and the second indication of the one or more available transmission time intervals; and prioritizing the second available transmission time interval based at least in part on the second downlink control information message being a non-scheduling downlink control information message.

Aspect 18: The method of any of aspects 16 through 17, further comprising: receiving, in the second downlink control information message, an aperiodic sounding reference signal trigger comprising a second code point, wherein the second code point comprises a first bit of the aperiodic sounding reference signal trigger indicating the second available transmission time interval for non-scheduling downlink control information messages and a second bit of the aperiodic sounding reference signal trigger indicating a third available transmission time interval for scheduling downlink control information messages; and prioritizing the second available transmission time interval based at least in part on receiving the second downlink control information message.

Aspect 19: A method for wireless communications at a base station, comprising: transmitting, to a UE, a radio resource control message comprising an indication of one or more available transmission time intervals for transmitting aperiodic sounding reference signals; transmitting, to the UE, a first downlink control information message triggering a transmission of one or more aperiodic sounding reference signals on a sounding reference signal resource set; and receiving, from the UE during a first available transmission time interval, the one or more aperiodic sounding reference signals on the sounding reference signal resource set, wherein the receiving during the first available transmission time interval is based at least in part on a first code point of the first downlink control information message and the indication of the one or more available transmission time intervals.

Aspect 20: The method of aspect 19, wherein the indication of the one or more available transmission time intervals comprises: an indication of a plurality of available transmission time intervals, each available transmission time interval of a set of available transmission time intervals corresponding to a respective code point of a set of codepoints comprising the first code point of the first downlink control information message.

Aspect 21: The method of any of aspects 19 through 20, wherein the indication of the one or more available transmission time intervals comprises: an indication of a single available transmission time interval, wherein a set of offset values from the single available transmission time interval correspond to respective code points of a set of codepoints comprising the first code point of the first downlink control information message.

Aspect 22: The method of aspect 21, further comprising: adding a first offset value of the set of offset values to the single available transmission time interval, the first offset value corresponding to the first code point; and identifying, based at least in part on the adding, the first available transmission time interval.

Aspect 23: The method of any of aspects 19 through 22, wherein the indication of the one or more available transmission time intervals comprises: an indication of the first available transmission time interval and a second available transmission time interval.

Aspect 24: The method of aspect 23, further comprising: transmitting, in the first downlink control information message, an aperiodic sounding reference signal trigger comprising the first code point, wherein the first code point comprises a first bit of the aperiodic sounding reference signal trigger indicating a first sounding reference signal configuration and a second bit of the aperiodic sounding reference signal trigger indicating the first available transmission time interval.

Aspect 25: The method of any of aspects 19 through 24, further comprising: transmitting, to the UE, a control message comprising an indication of one or more updated available transmission time intervals for transmitting aperiodic sounding reference signals, one or more updated values for a set of code points comprising the first code point, or any combination thereof.

Aspect 26: The method of aspect 25, wherein the control message comprises a MAC control element (CE).

Aspect 27: The method of aspect 26, wherein the indication of one or more updated available transmission time intervals or transmitting aperiodic sounding reference signals comprises: an instruction to add or remove one or more entries in a table indicating the available transmission time intervals, or an instruction to enable or disable one or more entries in a table indicating the available transmission time intervals, or both.

Aspect 28: The method of any of aspects 26 through 27, wherein the indication of one or more updated values for the set of code points comprises: an instruction to add or remove one or more code points of the set of code points, or an instruction to enable or disable one or more code points of the set of code points, or both.

Aspect 29: The method of any of aspects 26 through 28, wherein the MAC-CE comprises an instruction to modify a mapping between the set of code points and the available transmission time intervals.

Aspect 30: The method of any of aspects 19 through 29, further comprising: transmitting, to the UE, a second radio resource control message comprising a slot offset value indicating a second available transmission time interval for transmitting aperiodic sounding reference signals; transmitting, to the UE, a second downlink control information message triggering a transmission of one or more aperiodic sounding reference signals on a second sounding reference signal resource set; and receiving, from the UE during the second available transmission time interval, the one or more aperiodic sounding reference signals on the second sounding reference signal resource set, wherein the receiving during the second available transmission time interval is based at least in part on determining that one or more sounding reference signal configuration conditions are satisfied.

Aspect 31: The method of aspect 30, further comprising: determining that the second radio resource control message does not include the indication of the one or more available transmission time intervals for transmitting aperiodic sounding reference signals, wherein receiving the one or more aperiodic sounding reference signals during the second available transmission time interval is based at least in part on the determining.

Aspect 32: The method of any of aspects 30 through 31, further comprising: transmitting, in the second radio resource control message, an instruction to use the slot offset value indicating the second available transmission time interval, wherein receiving the one or more aperiodic sounding reference signals during the second available transmission time interval is based at least in part on transmitting the instruction

Aspect 33: The method of any of aspects 30 through 32, further comprising: identifying a format of the second downlink control information message, a core resource set associated with the second downlink control information message, a synchronization signal associated with the second downlink control information message, or any combination thereof, wherein receiving the one or more aperiodic sounding reference signals during the second available transmission time interval is based at least in part on the identifying.

Aspect 34: The method of any of aspects 19 through 33, further comprising: transmitting, to the base station, a second radio resource control message comprising a second indication of one or more available transmission time intervals for transmitting aperiodic sounding reference signals; transmitting, to the UE, a second downlink control information message triggering a transmission of one or more aperiodic sounding reference signals on a second sounding reference signal resource set, wherein the first downlink control information message is a scheduling downlink control information message and the second downlink control information message is a non-scheduling downlink control information message comprising an indication of a second available transmission time interval; and receiving, from the UE during the second available transmission time interval, the one or more aperiodic sounding reference signals on the second sounding reference signal resource set, wherein the receiving during the second available transmission time interval is based at least in part on the indication of the second available transmission time interval.

Aspect 35: The method of aspect 34, further comprising: identifying a third available transmission time interval based at least in part on a second code point of the second downlink control information message and the second indication of the one or more available transmission time intervals; and prioritizing the second available transmission time interval based at least in part on the second downlink control information message being a non-scheduling downlink control information message.

Aspect 36: The method of any of aspects 34 through 35, further comprising: transmitting, in the second downlink control information message, an aperiodic sounding reference signal trigger comprising a second code point, wherein the second code point comprises a first bit of the aperiodic sounding reference signal trigger indicating the second available transmission time interval for non-scheduling downlink control information messages and a second bit of the aperiodic sounding reference signal trigger indicating a third available transmission time interval for scheduling downlink control information messages; and prioritizing the second available transmission time interval based at least in part on receiving the second downlink control information message.

Aspect 37: An apparatus for wireless communications at a UE, comprising a processor; memory coupled with the processor; and instructions stored in the memory and executable by the processor to cause the apparatus to perform a method of any of aspects 1 through 18.

Aspect 38: An apparatus for wireless communications at a UE, comprising at least one means for performing a method of any of aspects 1 through 18.

Aspect 39: A non-transitory computer-readable medium storing code for wireless communications at a UE, the code comprising instructions executable by a processor to perform a method of any of aspects 1 through 18.

Aspect 40: An apparatus for wireless communications at a base station, comprising a processor; memory coupled with the processor; and instructions stored in the memory and executable by the processor to cause the apparatus to perform a method of any of aspects 19 through 36.

Aspect 41: An apparatus for wireless communications at a base station, comprising at least one means for performing a method of any of aspects 19 through 36.

Aspect 42: A non-transitory computer-readable medium storing code for wireless communications at a base station, the code comprising instructions executable by a processor to perform a method of any of aspects 19 through 36.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope and spirit of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving, from a base station, a radio resource control message comprising an indication of one or more available transmission time intervals for transmitting aperiodic sounding reference signals;
receiving, from the base station, a first downlink control information message triggering a transmission of one or more aperiodic sounding reference signals on a sounding reference signal resource set; and
transmitting, to the base station during a first available transmission time interval, the one or more aperiodic sounding reference signals on the sounding reference signal resource set, wherein the transmitting during the first available transmission time interval is based at least in part on a first code point of the first downlink control information message and the indication of the one or more available transmission time intervals.

2. The method of claim 1, wherein the indication of the one or more available transmission time intervals comprises:
an indication of a plurality of available transmission time intervals, each available transmission time interval of the plurality of available transmission time intervals corresponding to a respective code point of a set of code points comprising the first code point of the first downlink control information message.

3. The method of claim 1, wherein the indication of the one or more available transmission time intervals comprises:
an indication of a single available transmission time interval, wherein each offset value of a set of offset values from the single available transmission time interval corresponds to respective code points of a set of code points comprising the first code point of the first downlink control information message.

4. The method of claim 3, further comprising:
adding a first offset value of the set of offset values to the single available transmission time interval, the first offset value corresponding to the first code point; and
identifying, based at least in part on the adding, the first available transmission time interval.

5. The method of claim 1, further comprising:
receiving, from the base station, a control message comprising an indication of one or more updated available transmission time intervals for transmitting aperiodic sounding reference signals, one or more updated values for a set of code points comprising the first code point, or any combination thereof.

6. The method of claim 5, wherein the control message comprises a media access control (MAC) control element (CE).

7. The method of claim 6, wherein the indication of one or more updated available transmission time intervals or transmitting aperiodic sounding reference signals comprises:
an instruction to add or remove one or more entries in a table indicating the available transmission time intervals, or an instruction to enable or disable one or more entries in a table indicating the available transmission time intervals, or both.

8. The method of claim 6, wherein the indication of one or more updated values for the set of code points comprises:
an instruction to add or remove one or more code points of the set of code points, or an instruction to enable or disable one or more code points of the set of code points, or both.

9. The method of claim 6, wherein the MAC-CE comprises an instruction to modify a mapping between the set of code points and the available transmission time intervals.

10. The method of claim 1, further comprising:
receiving, from the base station, a second radio resource control message comprising a slot offset value indicating a second available transmission time interval for transmitting aperiodic sounding reference signals;
receiving, from the base station, a second downlink control information message triggering a transmission of one or more aperiodic sounding reference signals on a second sounding reference signal resource set; and
transmitting, to the base station during the second available transmission time interval, the one or more aperiodic sounding reference signals on the second sounding reference signal resource set, wherein the transmitting during the second available transmission time interval is based at least in part on determining that one or more sounding reference signal configuration conditions are satisfied.

11. The method of claim 10, further comprising:
determining that the second radio resource control message does not include the indication of the one or more available transmission time intervals for transmitting aperiodic sounding reference signals, wherein transmitting the one or more aperiodic sounding reference signals during the second available transmission time interval is based at least in part on the determining.

12. The method of claim 10, further comprising:
receiving, in the second radio resource control message, an instruction to use the slot offset value indicating the second available transmission time interval, wherein transmitting the one or more aperiodic sounding reference signals during the second available transmission time interval is based at least in part on receiving the instruction.

13. The method of claim 10, further comprising:
identifying a format of the second downlink control information message, a core resource set associated with the second downlink control information message, a synchronization signal associated with the second downlink control information message, or any combination thereof, wherein transmitting the one or more aperiodic sounding reference signals during the second available transmission time interval is based at least in part on the identifying.

14. The method of claim 1, further comprising:
receiving, from the base station, a second radio resource control message comprising a second indication of one or more available transmission time intervals for transmitting aperiodic sounding reference signals;
receiving, from the base station, a second downlink control information message triggering a transmission of one or more aperiodic sounding reference signals on a second sounding reference signal resource set, wherein the first downlink control information message is a scheduling downlink control information message and the second downlink control information message is a non-scheduling downlink control information message comprising an indication of a second available transmission time interval; and
transmitting, to the base station during the second available transmission time interval, the one or more aperiodic sounding reference signals on the second sounding reference signal resource set, wherein the transmitting during the second available transmission time interval is based at least in part on the indication of the second available transmission time interval.

15. The method of claim 14, further comprising:
identifying a third available transmission time interval based at least in part on a second code point of the second downlink control information message and the second indication of the one or more available transmission time intervals; and
prioritizing the second available transmission time interval based at least in part on the second downlink control information message being a non-scheduling downlink control information message.

16. The method of claim 14, further comprising:
receiving, in the second downlink control information message, an aperiodic sounding reference signal trigger comprising a second code point, wherein the second code point comprises a first bit of the aperiodic sounding reference signal trigger indicating the second available transmission time interval for non-scheduling downlink control information messages and a second bit of the aperiodic sounding reference signal trigger indicating a third available transmission time interval for scheduling downlink control information messages; and
prioritizing the second available transmission time interval based at least in part on receiving the second downlink control information message.

17. The method of claim 1, wherein the indication of the one or more available transmission time intervals comprises:
an indication of the first available transmission time interval and a second available transmission time interval.

18. The method of claim 17, further comprising:
receiving, in the first downlink control information message, an aperiodic sounding reference signal trigger comprising the first code point, wherein the first code point comprises a first bit of the aperiodic sounding reference signal trigger indicating a first sounding reference signal configuration and a second bit of the aperiodic sounding reference signal trigger indicating the first available transmission time interval.

19. A method for wireless communications at a base station, comprising:
transmitting, to a user equipment (UE), a radio resource control message comprising an indication of one or more available transmission time intervals for transmitting aperiodic sounding reference signals;
transmitting, to the UE, a first downlink control information message triggering a transmission of one or more aperiodic sounding reference signals on a sounding reference signal resource set; and
receiving, from the UE during a first available transmission time interval, the one or more aperiodic sounding reference signals on the sounding reference signal resource set, wherein the receiving during the first available transmission time interval is based at least in part on a first code point of the first downlink control information message and the indication of the one or more available transmission time intervals.

20. The method of claim 19, wherein the indication of the one or more available transmission time intervals comprises:
an indication of a plurality of available transmission time intervals, each available transmission time interval of the plurality of available transmission time intervals corresponding to a respective code point of a set of code points comprising the first code point of the first downlink control information message.

21. The method of claim 19, wherein the indication of the one or more available transmission time intervals comprises:
an indication of a single available transmission time interval, wherein each offset value of a set of offset values from the single available transmission time interval corresponds to respective code points of a set of code points comprising the first code point of the first downlink control information message.

22. The method of claim 21, further comprising:
adding a first offset value of the set of offset values to the single available transmission time interval, the first offset value corresponding to the first code point; and
identifying, based at least in part on the adding, the first available transmission time interval.

23. The method of claim 19, further comprising:
transmitting, to the UE, a second radio resource control message comprising a slot offset value indicating a second available transmission time interval for transmitting aperiodic sounding reference signals;
transmitting, to the UE, a second downlink control information message triggering a transmission of one or more aperiodic sounding reference signals on a second sounding reference signal resource set; and
receiving, from the UE during the second available transmission time interval, the one or more aperiodic sounding reference signals on the second sounding reference signal resource set, wherein the receiving during the second available transmission time interval is based at least in part on determining that one or more sounding reference signal configuration conditions are satisfied.

24. The method of claim 23, further comprising:
determining that the second radio resource control message does not include the indication of the one or more available transmission time intervals for transmitting aperiodic sounding reference signals, wherein receiving the one or more aperiodic sounding reference signals during the second available transmission time interval is based at least in part on the determining.

25. The method of claim 23, further comprising:
transmitting, in the second radio resource control message, an instruction to use the slot offset value indicating the second available transmission time interval, wherein receiving the one or more aperiodic sounding reference signals during the second available transmission time interval is based at least in part on transmitting the instruction.

26. The method of claim 23, further comprising:
identifying a format of the second downlink control information message, a core resource set associated with the second downlink control information message, a synchronization signal associated with the second downlink control information message, or any combination thereof, wherein receiving the one or more aperiodic sounding reference signals during the second available transmission time interval is based at least in part on the identifying.

27. The method of claim 19, further comprising:
transmitting, to the base station, a second radio resource control message comprising a second indication of one or more available transmission time intervals for transmitting aperiodic sounding reference signals;
transmitting, to the UE, a second downlink control information message triggering a transmission of one or more aperiodic sounding reference signals on a second sounding reference signal resource set, wherein the first downlink control information message is a scheduling downlink control information message and the second downlink control information message is a non-scheduling downlink control information message comprising an indication of a second available transmission time interval; and
receiving, from the UE during the second available transmission time interval, the one or more aperiodic sounding reference signals on the second sounding reference signal resource set, wherein the receiving during the second available transmission time interval is based at least in part on the indication of the second available transmission time interval.

28. The method of claim 27, further comprising:
identifying a third available transmission time interval based at least in part on a second code point of the second downlink control information message and the second indication of the one or more available transmission time intervals; and
prioritizing the second available transmission time interval based at least in part on the second downlink control information message being a non-scheduling downlink control information message.

29. An apparatus for wireless communications at a user equipment (UE), comprising:
a processor;
memory coupled with the processor; and
instructions stored in the memory and executable by the processor to cause the apparatus to:
receive, from a base station, a radio resource control message comprising an indication of one or more available transmission time intervals for transmitting aperiodic sounding reference signals;
receive, from the base station, a first downlink control information message triggering a transmission of one or more aperiodic sounding reference signals on a sounding reference signal resource set; and
transmit, to the base station during a first available transmission time interval, the one or more aperiodic sounding reference signals on the sounding reference signal resource set, wherein the transmitting during the first available transmission time interval is based at least in part on a first code point of the first downlink control information message and the indication of the one or more available transmission time intervals.

30. An apparatus for wireless communications at a base station, comprising:
a processor;
memory coupled with the processor; and
instructions stored in the memory and executable by the processor to cause the apparatus to:
transmit, to a user equipment (UE), a radio resource control message comprising an indication of one or more available transmission time intervals for transmitting aperiodic sounding reference signals;
transmit, to the UE, a first downlink control information message triggering a transmission of one or more aperiodic sounding reference signals on a sounding reference signal resource set; and
receive, from the UE during a first available transmission time interval, the one or more aperiodic sounding reference signals on the sounding reference signal resource set, wherein the receiving during the first available transmission time interval is based at least in part on a first code point of the first downlink control information message and the indication of the one or more available transmission time intervals.
